(19) United States
(12) Patent Application Publication
(10) Pub. No.: US 2025/0076872 A1
(43) Pub. Date: Mar. 6, 2025

(54) VEHICLE FOLLOW AND SAFETY

(71) Applicant: Zimeno Inc., Livermore, CA (US)

(72) Inventors: Christopher Travis WHITNEY, Palo Alto, CA (US); Rama Venkata Surya Kumar Varma Bhupatiraju, Milpitas, CA (US)

(73) Assignee: Zimeno Inc., Livermore, CA (US)

(21) Appl. No.: 18/945,495

(22) Filed: Nov. 12, 2024

Related U.S. Application Data
(63) Continuation-in-part of application No. 18/370,948, filed on Sep. 21, 2023, now Pat. No. 12,158,754.
Application No. 18/370,948 is a continuation of application No. 18/090,450, filed on Dec. 28, 2022, now Pat. No. 11,774,958.
Application No. 18/090,450 is a continuation of application No. 17/114,231, filed on Dec. 7, 2020, now Pat. No. 11,567,492.
(63) Continuation-in-part of application No. 18/239,217, filed on Aug. 29, 2023, now Pat. No. 12,158,753.
Application No. 18/239,217 is a continuation of application No. 18/090,450, filed on Dec. 28, 2022, now Pat. No. 11,774,958.
(60) Provisional application No. 62/962,752, filed on Jan. 17, 2020.
(60) Provisional application No. 63/548,147, filed on Nov. 10, 2023.

(51) Int. Cl. G05D 1/00; B60K 17/28; B60Q 1/44; B60Q 1/46; B60Q 1/50; B60Q 5/00; B60R 25/23; B60R 25/24; B60R 25/25; G05D 1/223; G05D 1/224; G05D 1/226; G05D 1/249; G05D 1/65; G05D 1/689; G06F 16/40; G06N 3/042

(52) U.S. Cl. CPC G05D 1/0016; B60K 17/28; B60Q 1/44; B60Q 1/46; B60Q 1/50; B60Q 5/001; B60R 25/23; B60R 25/24; B60R 25/25; G05D 1/223; G05D 1/224; G05D 1/249; G05D 1/65; G05D 1/689; G06F 16/40; G05D 1/226; G06N 3/042

(57) ABSTRACT

A vehicle zone control system may include a tractor having a propulsion unit and a steering unit, at least sensor carried by the tractor and stored data defining a plurality of zones proximate the vehicle. The system determines in which of the plurality of zones a remote operator on ground proximate the tractor currently resides based upon signals from the at least one sensor. The system differently controls at least one of the propulsion unit and the steering unit based upon in which zone the remote operator currently resides.

### CROSS-REFERENCE TO RELATED PATENT APPLICATIONS

The present application also claims priority under 35 USC § 120 from co-pending U.S. patent application Ser. No. 18/370,948 filed on Sep. 21, 2023, by Whitney et al. which claims priority under 35 USC § 120 from U.S. patent application Ser. No. 18/090,450 filed on Dec. 28, 2022, by Whitney et al. which claims priority under 35 USC § 120 from U.S. patent application Ser. No. 17/114,231 filed on Dec. 7, 2020 (U.S. Pat. No. 11,567,492), by Whitney et al, which claims priority under 35 USC § 119 from U.S. Provisional Patent Application Ser. No. 62/962,752 filed on Jan. 17, 2020, by Whitney et al. and entitled VEHICLE CONTROL BY A REMOTE OPERATOR, the full disclosures of which are hereby incorporated by reference. The present application is related to U.S. patent application Ser. No. 18/239,217 filed on Aug. 29, 2023, the full disclosure of which are hereby incorporated by reference.

The present application also claims priority under 35 USC § 120 from co-pending U.S. patent application Ser. No. 18/239,217 filed on Aug. 29, 2023, by Whitney et al. which claims priority under 35 USC § 120 from U.S. patent application Ser. No. 18/090,450 filed on Dec. 28, 2022, by Whitney et al. which claims priority under 35 USC § 120 from U.S. patent application Ser. No. 17/114,231 filed on Dec. 7, 2020 (U.S. Pat. No. 11,567,492), by Whitney et al, which claims priority under 35 USC § 119 from U.S. Provisional Patent Application Ser. No. 62/962,752 filed on Jan. 17, 2020, by Whitney et al. and entitled VEHICLE CONTROL BY A REMOTE OPERATOR, the full disclosures of which are hereby incorporated by reference. The present application is related to US patent application Ser. No. 18/239,217 filed on Aug. 29, 2023, the full disclosure of which are hereby incorporated by reference.

The present application also claims priority under 35 USC § 120 from U.S. Provisional Patent Application Ser. No. 63/548,147 filed on Nov. 10, 2023, by Whitney et al., the full disclosure of which is incorporated by reference.

### BACKGROUND

Vehicles may perform various vehicle actions in response to inputs or commands from an operator. For example, the direction in which a vehicle travels and/or speed of travel may be controlled by an operator sitting in the vehicle and manipulating a steering wheel, joystick, accelerator pedal, brake pedal and the like. Various attachments or extensions of the vehicle may also be controlled from the operator sitting or otherwise boarded upon the vehicle.

### BRIEF DESCRIPTION OF THE DRAWINGS

FIG. 1 is a block diagram schematically illustrating portions of an example vehicle control system.

FIG. 2 is a flow diagram of an example vehicle control method.

FIG. 3 is a block diagram schematically illustrating portions of an example vehicle control system.

FIG. 4 is a block diagram schematically illustrating portions of an example vehicle control system.

FIG. 5 is a front perspective view of an example vehicle control system.

FIG. 6 is a rear perspective view of the example vehicle control system of FIG. 5.

FIG. 7 is a right-side view of the example vehicle control system of FIG. 5.

FIG. 8 is a left side view of the example vehicle control system of FIG. 5.

FIG. 9 is a front view of the example vehicle control system of FIG. 5.

FIG. 10 is a right side rear view of the example vehicle control system.

FIG. 11 is a bottom perspective view of the example vehicle control system taken along line 11-11 of FIG. 2.

FIG. 12 is a side view of an example vehicle control system.

FIG. 13 is a front view of the example vehicle control system of FIG. 12.

FIG. 14 is a rear view of the example vehicle control system of FIG. 12.

FIG. 15 is a front perspective view of the example vehicle control system of FIG. 12.

FIG. 16 is a top view illustrating an example safe zone and detection zone for use by the vehicle control system of FIG. 12.

FIG. 17 is a top view illustrating an example scenario with a remote operator leaving the detection zone.

FIG. 18 is a top view illustrating an example safe zone and an example detection zone.

FIG. 19 is a top illustrating an example rear safe zone and an example rear detection zone.

FIG. 20 is a flow diagram of an example zone-based method for entering and exiting a follow mode for use by the system of FIG. 12.

FIG. 21 is a top view illustrating a plurality of example zones for the method of FIG. 20.

FIG. 22 is a top view illustrating a vehicle of the system of FIG. 12 in an example forward follow mode.

FIGS. 23, 24, 25, 26, 27, 28, 29, 30, 31, 32, 33, 34, 35, 36 and 37 are top views illustrating different example scenarios pursuant to the method of FIG. 20.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are vehicle control systems, methods and mediums that facilitate control of a vehicle by an operator remote from the vehicle. As a result, vehicle actions that might otherwise demand multiple people, one person remote from the vehicle on the ground and another person boarded upon the vehicle and controlling the vehicle may be carried out by a single operator. As a result, vehicle actions that might otherwise demand that an operator boarding the vehicle repeatedly leave the vehicle to get a new perspective then re-boarding the vehicle may be performed with fewer or no re-boards.

For purposes of this disclosure, the term “processing unit” shall mean a presently developed or future developed computing hardware that executes sequences of instructions contained in a non-transitory memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, a controller may be embodied as part of one or more application-specific integrated circuits (ASICs). Unless otherwise specifically noted, the controller is not limited to any specific combination of hardware circuitry and software, nor to any particular source for the instructions executed by the processing unit.

For purposes of this disclosure, unless otherwise explicitly set forth, the recitation of a “processor”, “processing unit” and “processing resource” in the specification, independent claims or dependent claims shall mean at least one processor or at least one processing unit. The at least one processor or processing unit may comprise multiple individual processors or processing units at a single location or distributed across multiple locations.

For purposes of this disclosure, the term “coupled” shall mean the joining of two members directly or indirectly to one another. Such joining may be stationary in nature or movable in nature. Such joining may be achieved with the two members, or the two members and any additional intermediate members being integrally formed as a single unitary body with one another or with the two members or the two members and any additional intermediate member being attached to one another. Such a joining may be permanent in nature or alternatively may be removable or releasable in nature. The term “operably coupled” shall mean that two members are directly or indirectly joined such that motion may be transmitted from one member to the other member directly or via intermediate members.

For purposes of this disclosure, the phrase “configured to” denotes an actual state of configuration that fundamentally ties the stated function/use to the physical characteristics of the feature proceeding the phrase “configured to”.

For purposes of this disclosure, the term “releasably” or “removably” with respect to an attachment or coupling of two structures means that the two structures may be repeatedly connected and disconnected to and from one another without material damage to either of the two structures or their functioning.

For purposes of this disclosure, unless explicitly recited to the contrary, the determination of something “based on” or “based upon” certain information or factors means that the determination is made as a result of or using at least such information or factors; it does not necessarily mean that the determination is made solely using such information or factors. For purposes of this disclosure, unless explicitly recited to the contrary, an action or response “based on” or “based upon” certain information or factors means that the action is in response to or as a result of such information or factors; it does not necessarily mean that the action results solely in response to such information or factors.

For purposes of this, unless explicitly recited to the contrary, recitations reciting that signals “indicate” a value or state means that such signals either directly indicate a value, measurement or state, or indirectly indicate a value, measurement or state. Signals that indirectly indicate a value, measure or state may serve as an input to an algorithm or calculation applied by a processing unit to output the value, measurement or state. In some circumstances, signals may indirectly indicate a value, measurement or state, wherein such signals, when serving as input along with other signals to an algorithm or calculation applied by the processing unit may result in the output or determination by the processing unit of the value, measurement or state.

For purposes of disclosure, the term “remote”, when referring to an operator, means that the operator is not locally located with respect to the direct control devices of the vehicle such as a steering wheel, joystick, acceleration or brake pedals, gearshift levers, push buttons, switches, other levers and the like. In some implementations, a remote operator may be an operator that is standing on a part of the vehicle or an attachment of the vehicle, but wherein the operator cannot access the steering wheel or other input controls of the vehicle. For example, an operator may be located on a platform, bucket, or other attachment of the vehicle, but cannot readily ask the steering will other input controls of the vehicle. In some implementations, a remote operator may be an operator that is not boarded upon the vehicle. For example, a remote operator may be an operator standing on the ground in front of, behind of or to a side of the vehicle. In some implementations, a remote operator may be an operator that is standing or otherwise carried by an implement being pushed or pulled by the vehicle. In each case, the operator is remote from the direct control structures (steering wheel, joystick, push buttons, switches, levers, and the like) of the vehicle.

In some implementations, a remote operator may be an operator that cannot readily reach, contact or physically access the direct input interfaces for a particular vehicle action, wherein disclosed vehicle control systems, methods and mediums facilitate initiating, stopping or adjusting such vehicle actions by an operator through the use of direct or indirect gestures by the operator that are sensed by a sensor of the vehicle. Direct gestures comprise movement or positioning of the operator's anatomy such as movement or positioning of the operator's hands, arms, or legs. Indirect gestures of an operator may comprise manual movement or positioning of an input device by an operator, wherein the movement or positioning of the input device is sensed by sensor of the vehicle. In such circumstances, an operator who is positioned so as to not be able to physically contact and move a direct input device (steering wheel, joystick, push buttons, switches, levers and the like) for a desired vehicle action may still provide input to the vehicle initiating, stopping or adjusting such a vehicle action.

FIG. 1 is a block diagram schematically illustrating an example vehicle control system 20. Vehicle control system 20 comprises vehicle 24, sensor 28, processor 32 and a non-transitory computer-readable medium 40. Vehicle 24 comprises a self-propelled vehicle. Examples of vehicle 24 include, but are not limited to, trucks, cars, tractors, harvesters, riding lawnmowers, snow throwers, four wheelers, all-terrain vehicles, and the like.

Sensor 28 comprises at least one sensor carried by vehicle 24 that is supported by vehicle 24 so as to be able to sense direct or indirect gestures initiated by an operator 42. The direct gestures provided by operator 42 may be provided by the operator's anatomy 44, such as a movement or positioning of the operator's hands, fingers, legs, torso, or the like. The movement, positioning/orientation of the operator's anatomy may serve as input 46 which is sensed by sensor 28. Indirect gestures initiated by operator 42 may involve the movement and/or positioning of an input device 48 which serves as input 46. The input device 48 may comprise a flag, a baton, a smart phone or other handheld or portable physical structure that may be manually manipulated by the operator 42 and that is recognizable by sensor 28.

Sensor 28 may have varying fields of view or sensing ranges. In some implementations, particular regions about vehicle 24 that are within the particular field of view of at least one of sensors 28 may be designated for providing remote input to vehicle 24. In other implementations, the at least one sensor 28 may have a field-of-view or multiple fields of view that encompass an entire area about vehicle 24 such that a remote operator may provide remote input at any of various possible locations about vehicle 24.

In some implementations, sensor 28 comprises at least one camera supported by vehicle 24. In other implementations, sensor 28 may comprise other forms of non-contact or wireless sensors such as lidar, radar, ultrasonic sensors, and the like. In some implementations, different types of sensors may be provided at different locations about the vehicle.

Processor 32 and medium 40 form a controller for vehicle 24. Although processor 32 and medium 40 are illustrated as being part of or carried by vehicle 24, in some implementations, processor 32 and medium 40 may be located remote from vehicle 24, not being carried by vehicle 24. In such implementations, the controller formed by processor 32 and medium 40 may communicate with a local controller on vehicle 24 in a wireless manner. Processor 32 carries out instructions provided in medium 40. Medium 40 may contain additional instructions (not illustrated) for controlling other operations of vehicle 24.

Medium 40 may be in the form of software or coding on a flash drive, memory disk, or the like and/or hardware in the form of logic elements on a circuit board. The instructions contained in medium 40, that direct processor 32, comprise remote operator input sensing instructions 56, input recognition instructions 58 and input response control instructions 64. Remote operator input sensing instructions 56 comprise instructions configured to obtain sensed input from the remote operator 42. Such instruction direct processor 32 to pull or otherwise acquire signals from sensor 28 indicating the positioning and/or movement of operator anatomy 44 and/or input device 48. Instructions 56 may further direct processor 32 to determine such positioning or movement from the signals provided by sensor 28.

In one implementation, system 20 is selectively actuatable between different modes. In a first mode, sensor 28 may sense the positioning and/or movement of operator anatomy 44 and use such positioning and/or movement to control actions of vehicle 24. In a second mode, sensor 28 may sense the positioning and/or movement of input device 48 and use such positioning and/or movement to control actions of vehicle 24. In some implementations, the acquisition of signals from sensor 28 for facilitating remote control of vehicle 24 and/or the generation of control signals for one or more vehicle actions based upon a sensed gesture of operator 42 may be continuous or may be initiated in response to an input provided by the operator 42 through a direct input control, such as while the operator is boarded upon vehicle 24. In some implementations, the acquisition of signals from sensor 28 for facilitating remote control of vehicle 24 and/or the generation of control signals for one or more vehicle actions based upon a sensed gesture of operator 42 may be triggered or initiated in response to signals indicating that the operator is no longer boarded upon vehicle 24. For example, in some implementations, sensor 28 and/or the remote-control process of system 20 may be in a dormant mode and may be woken in response to signals from a sensor indicating that the operator has left vehicle 24. In one implementation, one or more sensors may be located below the operator's chair or seat in vehicle 24, wherein the sensor 28 and/or the remote-control process provided by system 20 may be awoken in response to such sensors indicating that the operator is no longer seated.

Input recognition instructions 58 comprise instructions configured to direct processor 32 to recognize and associate sensed input with a particular requested vehicle action. For example, an operator 42 pointing his or her hand in a downward direction may be interpreted as a command to decrease the forward or rearward velocity of the vehicle, whereas the operator 42 pointing his hand in an upward direction may be interpreted as a command to increase the forward or rearward velocity. An operator 42 pointing input device 48 in a downward direction may be interpreted as a command to decrease the forward or rearward velocity of the vehicle, whereas the operator 42 pointing the input device 48 in an upward direction may be interpreted as command to increase the forward or rearward velocity. The operator 42 pointing his hand in a leftward direction or pointing the input device 48 in the leftward direction may be interpreted as a command to turn the vehicle in a leftward direction, wherein the duration which the hand is pointed in the left direction indicates the extent or angle of the turn. An operator pointing his or her hand or input device directly at vehicle 24 may be interpreted as a command to back up the vehicle.

In one implementation, input recognition instructions 58 may direct processor 32 to discern between the operator's left-hand and right-hand, wherein different gestures provided by the left-hand or the right hand (or an input device carried by the left-hand or right-hand), may be interpreted as different commands. For example, gestured by the left-hand may be interpreted as providing commands for the speed of the vehicle whereas gestures provided by the right hand may be interpreted as providing commands for movement of an attachment or implement of the vehicle.

In one implementation, medium 40 may additionally include a database or lookup table associating different sensed inputs (different sensed gestures) with different vehicle commands or actions. In some implementations, the database may be local, carried by vehicle 24. In other implementations, the database may be remote from vehicle 24. In some implementations, the database may be a generic database provided by a remote server, wherein the database is accessible to multiple different vehicles 24 and different systems 20 being operated by different operators 42. In some implementations, the database may be specific to the particular operator 42. In some implementations, the database may be part of a neural network that is been trained using images, videos or other sets of sensed data, or the neural network recognizes different gestures and associates such gestures with different vehicle action commands or requests.

In some implementations, the input recognition instructions 58 may have different databases of associated commands and gestures for different individual sensors 28 supported at different positions by vehicle 24. A gesture received from a first sensor at a first location may correspond to a first vehicle action while the same gesture received from a second sensor at a second different location may correspond to a second different vehicle action. In some implementations, different sensors supported at different locations or positions on the vehicle may be dedicated or assigned to different vehicle actions. For example, a first sensor or group of sensors at a first location on a vehicle may be dedicated to receiving direct or indirect gestures for controlling a first type of vehicle action while a second sensor or a second group of sensors at a second location on the vehicle may be dedicated to receiving direct or indirect gestures for controlling a second different type of vehicle action. By way of a more specific example, a first sensor supported at a front end of a vehicle may be dedicated to receiving direct or indirect gestures for controlling the positioning of an attachment extending from the front of the vehicle, whereas a second sensor supported at a rear end of the vehicle may be dedicated to receiving direct or indirect gestures for controlling the positioning of an attachment extending from the rear of the vehicle. In some implementations, for an operator to provide remote input for a particular vehicle action, the operator must position himself or herself at a pre-determined or designated remote location relative to the vehicle such that his or her direct or indirect gestures are captured by the appropriate sensor that is designated for the desired vehicle action.

With such example implementations, an operator may be prevented from inadvertently providing an incorrect gesture for an incorrect command. For example, in one implementation, gestures associated with forward movement of the harvester may be only received from sensors positioned along or facing a side or rear of the vehicle 24. Sensors facing a front to vehicle 24 may be dedicated to other vehicle actions, but not forward movement of vehicle 24. In such implementations, the operator may be required to be along a side or rear of the vehicle, rather than in front of the vehicle when instructing forward movement of the vehicle.

By way of another example, one or more sensors having a field-of-view encompassing a power take off of the vehicle may be blocked or not be associated with receiving gestures corresponding to commands to turn on the power take off. In other words, only sensed gestures from sensors 28 having a field-of-view sufficiently distant from the power take off may be used to turn on the power take off. In such implementations, such assignments of sensors to particular vehicle actions may prevent an operator from becoming accidentally entangled in the power takeoff.

In some implementations, the association of different gestures with different requests or commands for particular vehicle actions may be additionally based upon other sensed parameters. For example, when vehicle 24 is carrying out a first operation or is in a first state (as sensed by sensors or otherwise determined by processor 32), recognition instructions 58 may direct processor 32 to consult a first table or database of gesture-vehicle action associations. When vehicle 24 is carrying out a second different operation or is in a second different state, recognition instructions 58 may direct processor 32 to consult a second table or database containing different gesture-vehicle action associations. By way of a specific example, instructions 58 may direct processor 32 to consult different databases containing different gesture-vehicle action associations depending upon the type or characteristics of attachment connected to vehicle 24 or depending upon the type or characteristic of the particular implement currently being pushed or pulled by vehicle 24. The type or characteristics of the attachment or implement may be input by the operator or may be sensed.

Input response control instructions 64 comprise instructions configured to output control signals to various actuators or the like of vehicle 24 to cause vehicle 24 to carry out the particular vehicle action corresponding to the sensed input as determined by instructions 58. Examples of various vehicle actions that may be associated with particular gestures (direct or indirect) from operator 42 in which may be carried out in response thereto include, but are not limited to vehicle actions consisting of: forward velocity, backward velocity, left/right direction, braking, lights (nightlights, running lights, spotlights), signal, sound (horn, loudspeaker), warning (flashing lights, hazard lights), implement specific actions (left sprayer on/off, right sprayer on/off, left implement wing raising and lowering, right implement wing raising and lowering, power take-up, moving a discharge spout, changing operational speed of the auger of a discharge spout, turning on/off of a power take off, adjusting a speed of the power takeoff, raising/lowering an attachment to the vehicle (such as a bucket, fork or the like), adjusting the supply of hydraulic fluid or hydraulic power to implement or attachment, raising/lowering a three point hitch in the like.

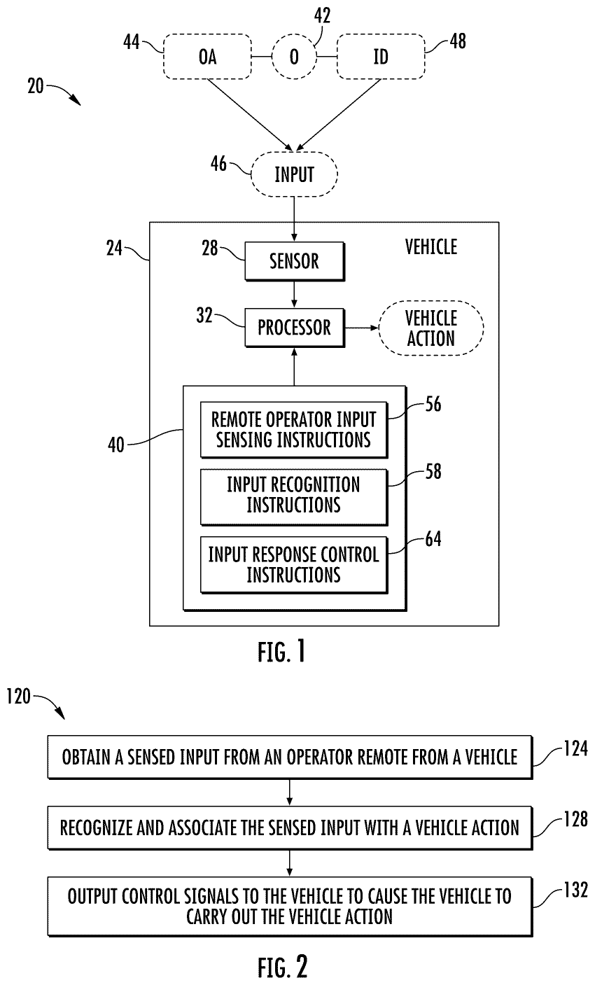

FIG. 2 is a flow diagram of an example vehicle control method 120. Although method 120 is described in the context of being carried out by system 20, it should be appreciated method 120 may likewise be carried out with any of the following described systems or with similar systems. As indicated by block 124, processor 32 may obtain a sensed input from an operator 42 remote from vehicle 24. The sensed input may be acquired from at least one sensor 28 carried by vehicle 24.

As indicated by block 128, processor 32 may recognize and associate the sensed input with a particular requested or commanded vehicle action. As described above, such association may be through the consultation of a local or remote database or lookup table associating different sensed inputs/gestures with different vehicle actions. In some implementations, the determination of the particular requested vehicle action corresponding to the sense input or gesture may additionally be based upon from which particular sensor 28 the sensed gesture was received and/or the particular state of vehicle 24, including the state or characteristic of any implement or attachment associated with vehicle 24. In some implementations, the operator 42 or other manager may provide system 20 with selections identifying which particular vehicle actions may be requested through the use of remote sensed gestures. For example, a database may include a multitude of available vehicle actions that may be controlled through the use of remote gestures, but where the operator or another person may authorize only a portion or a selected group of such available vehicle actions for control through remote gestures.

As indicated by block 132, processor 32 may output control signals to the vehicle 24 to cause a vehicle 24 to carry out the particular vehicle action currently associated with the sensed input/gesture from the remote operator 42. As described above, examples of such vehicle actions include, but are not limited to, forward velocity, backward velocity, left/right direction, braking, lights (nightlights, running lights, spotlights), signal, sound (horn, loudspeaker), warning (flashing lights, hazard lights), implement specific actions (left sprayer on/off, right sprayer on/off, left implement wing raising and lowering, right implement wing raising and lowering, power take-up, moving a discharge spout, changing operational speed of the auger of a discharge spout, turning on/off of a power take off, adjusting a speed of the power takeoff, raising/lowering an attachment to the vehicle (such as a bucket, fork or the like), adjusting the supply of hydraulic fluid or hydraulic power to an implement or attachment, raising/lowering of a three point hitch and the like.

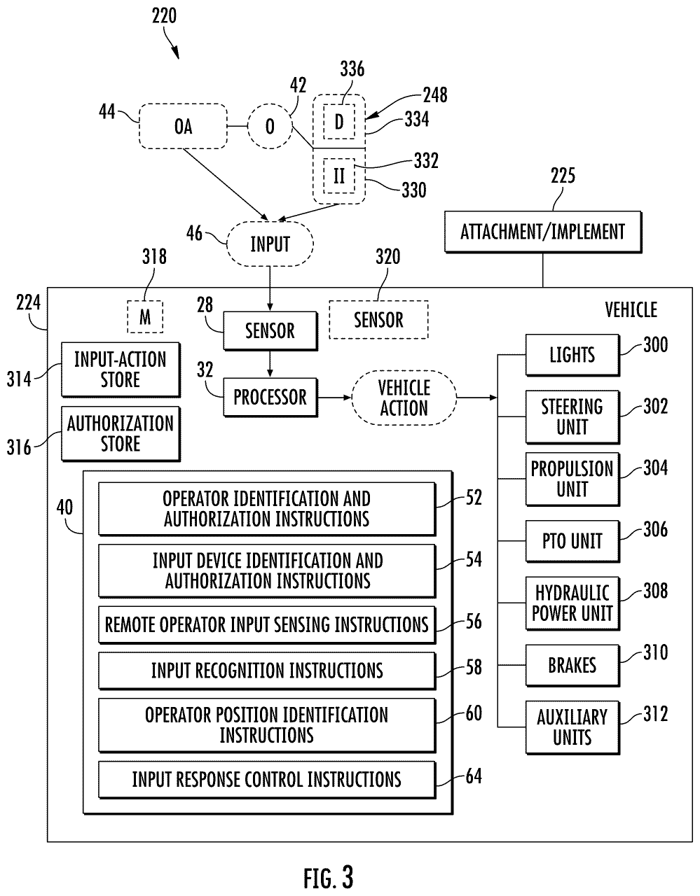

FIG. 3 is a block diagram schematically illustrated portions of an example vehicle control system 220. Vehicle control system 220 is similar to vehicle control system 20 described above except that vehicle control system 220 comprises vehicle 224 and input device 248 in place of vehicle 24 and input device 48. Vehicle 224 the additionally illustrated as being coupled to an attachment/implement 225.

Vehicle 224 is itself similar to vehicle 24 except that vehicle 224 is illustrated as specifically comprising lights 300, steering unit 302, propulsion unit 304, power take off (PTO) unit 306, hydraulic power unit 308, brakes 310 and auxiliary units 312. Vehicle 224 additionally comprises input-action store 314, authorization store 316, microphone 318 and sensor 320. Medium 40 additionally comprises operator identification and authorization instructions 52, input device identification and authorization instructions 54 and operator position identification instructions 60. The remaining components of vehicle 224 and system 220 which correspond to components of system 20 are numbered similarly.

Lights 300 comprise light supported by vehicle 224 for providing illumination about vehicle 224 or for providing alerts or notifications for vehicle 224. Steering unit 302 comprises electrical and/or hydraulic components and associated controllers that effectuate turning of the wheels, tracks, or the like to steer forward or rearward travel of vehicle 224. Propulsion unit 304 comprises an internal combustion engine, electric motor, transmission, and associated controllers for controlling the forward and rearward propulsion of vehicle 224. PTO unit 306 comprises an electrical, hydraulic, or mechanical drive and associate controllers for rotating the power take off (such as a projecting spline) for supplying torque to a fitting associated with an attachment or implement. Hydraulic power unit 308 comprises hydraulic pumps, valves, and associated controllers for supplying pressurized hydraulic fluid to portions of vehicle 224 or to attachments/implements powered by such pressurized hydraulic fluid from vehicle 224. Brakes 310 comprise devices for braking, slowing down the propulsion of vehicle 224. Auxiliary units 312 comprise movable or actuator components of vehicle 224. For example, auxiliary units 312 may comprise discharge spouts of a harvester, wherein the positioning of the discharge spout and/or the rotation of an auger of the discharge spout are adjustable.

Attachment/implement 225 comprises an attachment carried by vehicle 224 and/or an implement being pushed or pulled by vehicle 224. An attachment may be in the form of a bucket, blade, harvester head or the like. Examples of an implement may include any of a variety of implements such as wagons, carts, plows, discs, choppers, balers, sprayers, and the like. As discussed above, vehicle actions may involve repositioning such attachments or implements or adjusting the supply of power to such attachments or implements. The association of particular gestures to particular inputs/commands may vary depending upon what particular attachment implement is coupled to vehicle 224 and/or the current state of the particular attachment or implement coupled to vehicle 224. The same director indirect gesture may be associated with different commands depending upon the particular attachment or implement coupled to vehicle 224 and/or the current state of the particular attachment or implement coupled to vehicle 224.

Input-action store 314 comprises one or more databases or lookup tables linking various sensed gestures (direct or indirect) to associated requests or commands for vehicle actions.

Authorization store 316 comprises one or more databases or lookup tables identifying preauthorized operators and/or preauthorized input devices 248 for providing gestures for inputting requests or commands for vehicle actions. For example, authorization store 316 may comprise photographs of authorized operators 42, wherein authorization of an operator may be determined by comparing captured images of a candidate operator 42 and the photographs contained in the store 316. Authorization store 316 may comprise a pre-assigned set of passwords, wherein authorization for an operator 42 or an input device 248 may be determined by comparing a received password input through microphone 318 to the store 316. Authorization store 316 may comprise barcode values or other signatures for authorizing input devices 248. Input-action store 314 and authorization store 316 may be contained on medium 540 carried by vehicle 524 or may be stored in a remote memory or server, wherein vehicle 524 accesses stores 314, 316 through a wireless communication connection with the remote memory or server.

Operator identification and authorization instructions 52 comprise instructions for directing processor 32 to identify and authorize a candidate operator 42 for providing direct gestures for providing remote control commands for vehicle 224. Instructions 52 may direct sensor 28 or an alternative sensor, such as sensor 320 (in the form of a camera or other sensor) to capture images of operator 42 and then compare the received information or data to information found in authorization store 316. Based on such comparison, the operator 42 may be authorized for providing direct gestures for use in remotely controlling vehicle 224.

Input device identification and authorization instructions 54 comprise instructions for directing processor 32 to identify and authorize a candidate input device 248 doe providing direct gestures for providing remote control commands for vehicle 224. Instructions 54 may direct sensor 28 or an alternative sensor, such as sensor 320 (in the form of a camera or other sensor) to capture images a barcode or other indicia of input device 248 or receive an identification/authorization signal from input device 248, and then compare the received information or data to information found in authorization store 316. Based on such comparison, the input device 248 may be authorized for providing indirect gestures for use in remotely controlling vehicle 224.

Operator position identification instructions 60 comprise instructions that direct processor 32 to identify the positioning of the remote operator 42 relative to vehicle 224. Based upon the determined relative positioning, such instructions may further direct processor 32 to either outputting notification to the operator 42 recommending that the operator move relative to the vehicle or automatically interrupt the requested vehicle action corresponding to the sensed operator input/gesture. In such a fashion, instructions 60 may prevent vehicle actions from being carried out when the operator may be too close or out of position with respect to vehicle 224 for the vehicle action being requested.

Input device 248 comprises a handheld device to be manually manipulated, moved, or positioned by operator 42. Input device 248 comprises a first face 330 having an input identifier 332. Input identifier 332 is recognizable by sensor 28 and processor 32 following input recognition instructions 58. In some implementations, input identifier 332 may comprise flashing lights, particular patterns or shades of the color or other characteristics readily perceptible by sensor 28 to facilitate the sensing of the positioning and/or movement of input device 248.

Input device 248 additionally comprises a second opposite face 334 having a display 336. In one implementation, signals from sensor 28 or sensor 320 may be transmitted to input device 248, wherein a depiction of the region surrounding vehicle 224, based upon such signals, is presented on display 336. For example, one of sensor 28, 320 may comprise a camera carried by vehicle 224. The captured images may be transmitted to input device 248 and presented on display 336. As a result, the operator 42 providing remote commands to vehicle 224 may make such gestures and provide such commands based upon not only on his or her perspective which is remote from vehicle 224 but also based upon the perspective of the sensors 28 or 320 taken from the perspective of vehicle 224. Thus, the operator may make a more informed decisions regarding such remote commands. In one implementation, input device 248 may comprise a smart phone that wirelessly communicates with the controller provided by processor 32 and medium 40, wherein the positioning or movement of the smart phone serves as a remote gesture for providing remote commands to vehicle 224.

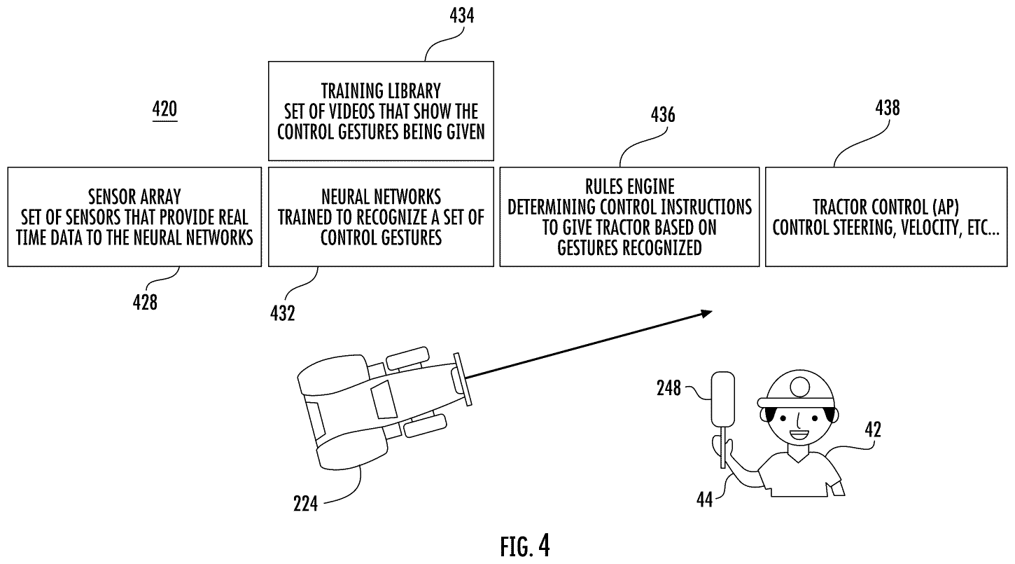

FIG. 4 is a schematic view illustrated portions of an example vehicle control system 420. As shown by FIG. 4, system 420 allows a driver to control the motion of a tractor, and actions of tools/devices attached to it whilst being physically removed from the tractor (such as standing in front of it). Sensors are mounted on the tractor so that the tractor can collect sensor data. The tractor analyzes the data to look for gestures that it has been trained to recognize. The tractor takes appropriate control changes dependent upon the gestures recognized. This system can be used to perform such tasks as instructing a tractor to follow the driver around a field or positioning a tractor within a closed space (such as garage).

As shown by FIG. 4, vehicle control system 420 comprises a sensor array 428 in the form of a set of sensors that sense and output real-time data regarding the input provided by operator 42 either through his or her anatomy 44 or through an input device, such as input device 248. The sensed data is transmitted to neural networks 432 which are trained to recognize a set of control gestures or inputs. Such recognition may be based upon training library 434 which may comprise a set of videos that show control gestures being given.

Vehicle control system 420 may further comprise rules engine 436 which comprises a processor and a non-transitory computer-readable medium that outputs control instructions for vehicle 224, in the form of a tractor, based upon the gestures or input identified by neural networks 432. As indicated by block 438, operation of vehicle 224 is adjusted based upon the control instructions. Such control instructions may involve steering, speed and the like as described above. For example, such control instructions may control the operation of lights 300, steering unit 302, propulsion unit 304, PTO unit 306, hydraulic power unit 308, brakes 310 and/or auxiliary unit 312.

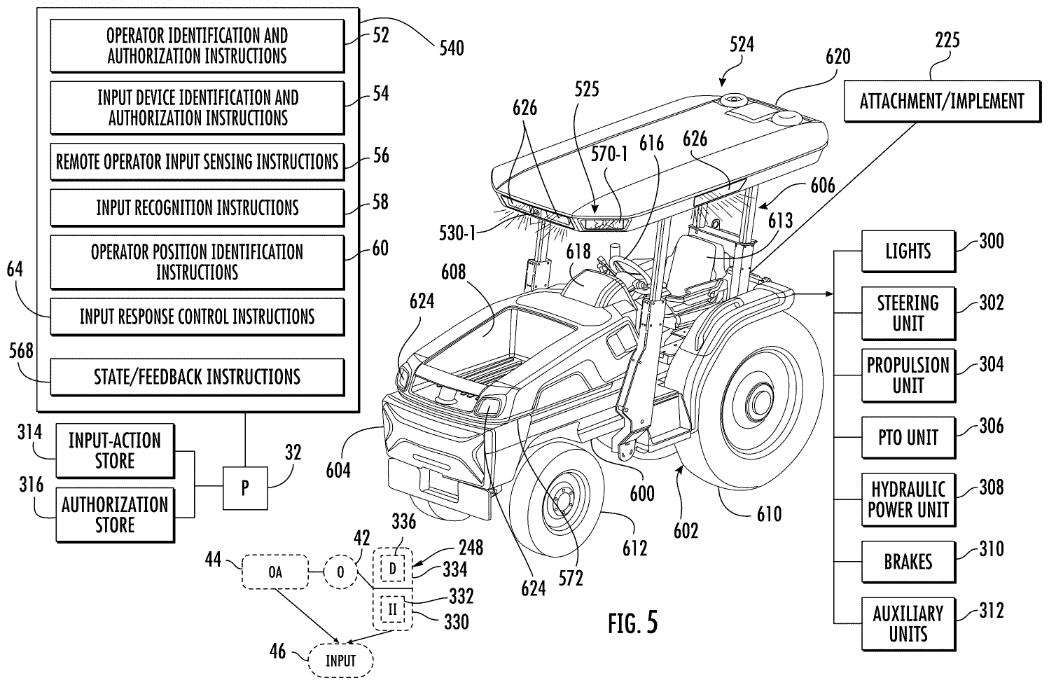

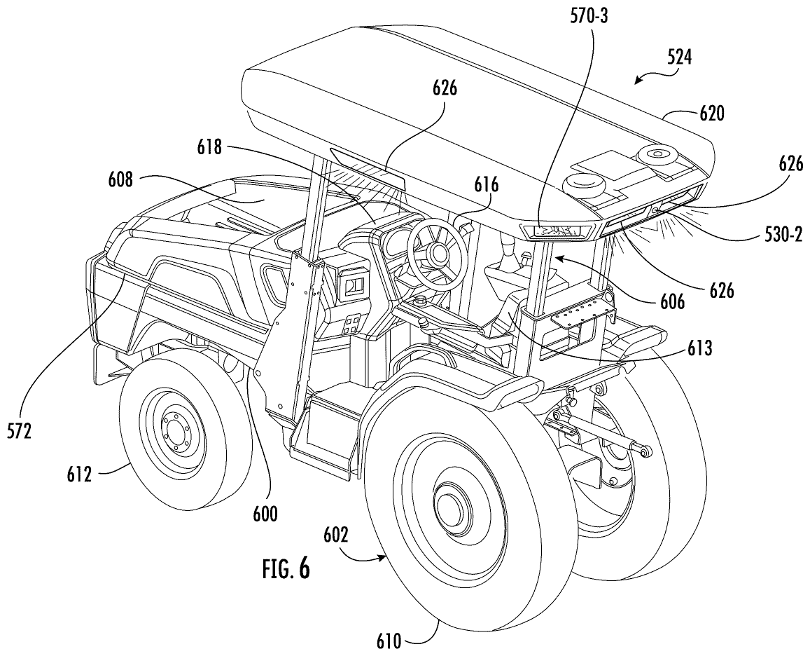

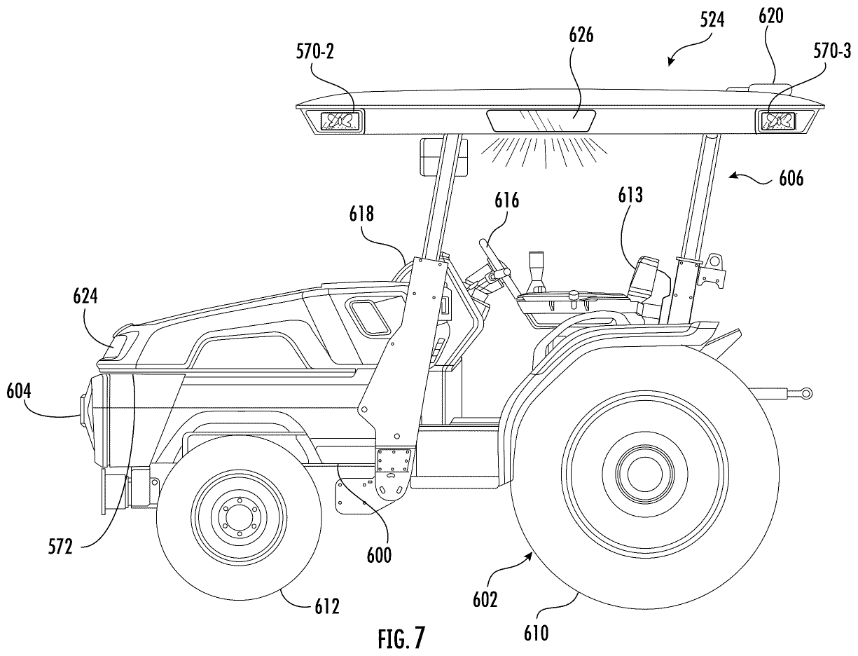

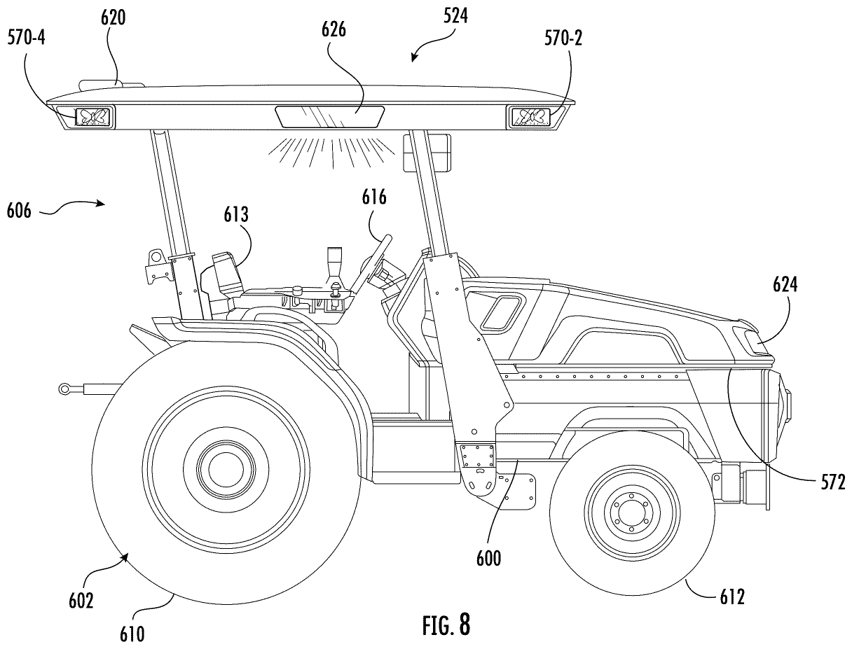

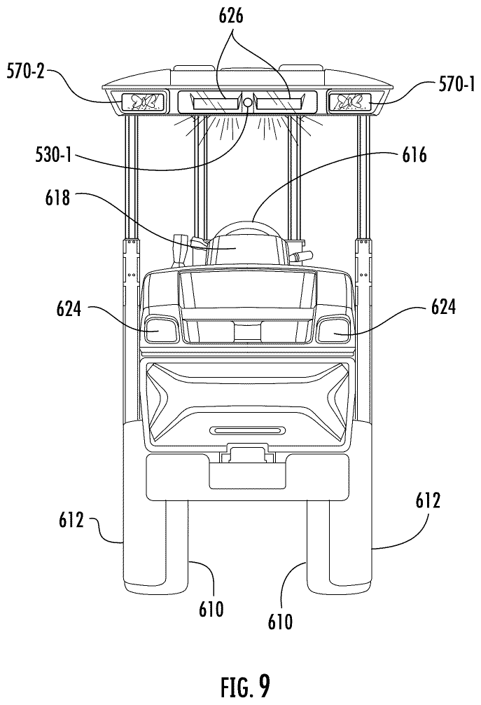

FIGS. 5-11 illustrate an example vehicle control system 520 for a vehicle 524 in the form of a tractor. Vehicle 524 is similar to vehicle 224 except that vehicle 524 additionally comprises vehicle state and feedback system 525. Vehicle state and feedback system 525 provides an operator, remote from vehicle 524, with visible and/or audible feedback regarding the state of vehicle 524. Such feedback may include the speed or rate at which the vehicle is traveling, the speed or state of an implement and/or the state of any of lights 300, steering unit 302, propulsion unit 304, PTO unit 308, brakes 310 auxiliary unit 312. Such feedback may include a confirmation of receipt or capture of gestures from the operator (either operator anatomy 44 and/or input device 248), a confirmation of recognition of such gestures, an indication that such commands are about to be executed, a request for the operator repeating such gestures, and/or an indication that the commands associated with such gestures will not be carried out given the current state of vehicle 524 or the operator's position relative to vehicle 524 and/or its implements.

Vehicle 524 may be used for a variety of purposes in agricultural construction and residential purposes. Vehicle 524 may be used to push or pull an implement. Vehicle 524 may include attachments, such as a bucket, blade, backhoe, or the like for digging, displacing, and/or carrying various materials such as earthen materials, animal waste and produce. Vehicle 524 may include forks or other coupling mechanisms for engaging pallets, bins, boxes, or the like, wherein the tractors carry and/or lift the engaged items.

Vehicle 524 comprises chassis 600, ground propulsion members 602, battery 604, and vehicle cab 606. Vehicle 524 further comprises lights 300, steering unit 302, propulsion unit 304, PTO unit 306, hydraulic power unit 308, brakes 310 and auxiliary unit 312. Chassis 600 comprises a frame supporting the remaining components of vehicle 524. In the example illustrated, chassis 600 comprises a front cargo bed 608 for storing and transporting cargo. In the example illustrated, chassis 600 is further configured for connection to an attachment/implement 225. In the example illustrated, propulsion unit 304 comprises an electric motor driven by electrical power supplied by a battery.

Ground propulsion members 602 comprise members that engage the underlying terrain and which are driven by propulsion unit 304. In the example illustrated, ground propulsion members 602 comprise rear wheels 610 and front wheels 612. In the example illustrated, rear wheel 610 are driven by propulsion unit 304 while front wheels 612 are manipulated or turned by steering unit 302. In other implementations, ground propulsion members 602 may comprise tracks or other ground engaging members.

Battery 604 comprises a battery unit that is removably received within a corresponding chamber or cavity extending rearwardly from the front of chassis 600. Battery 604 mates with a corresponding connection interface for transferring electrical power from battery 604 to the electrically powered components of vehicle 524. In other implementations, battery 604 may be located at other locations. In other implementations, battery 604 may be fixed and non-swappable or not removable. In the example illustrated, battery 604 electrically powers propulsion unit 304 which drives rear wheel 610. In the example illustrated, battery 604 electrically powers hydraulic motors or pumps of hydraulic power unit 308, steering unit 302 and brakes 310. Battery 604 additionally powers lights 300, attachment/implement 225, and auxiliary units 312.

Cab 606 comprises a compartment in which an operator may be seated when operating vehicle 524. Cab 606 comprises a seat 613, a steering wheel 616, a control console 618 and a roof 620. Roof 620 extends over seat 613 and control console 618. In some implementations, roof 620 may be raised and lowered.

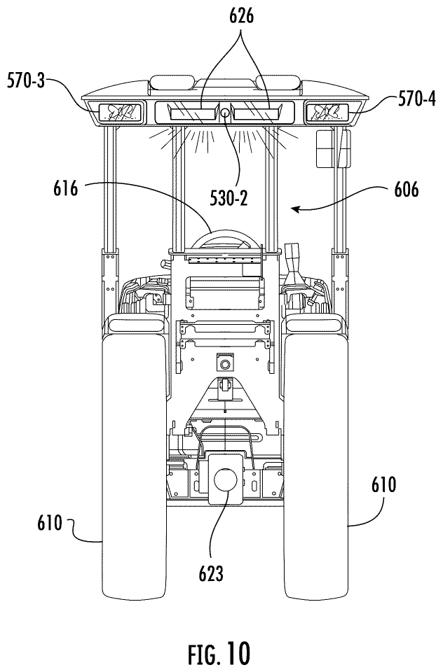

Lights 300, steering unit 302, propulsion unit 304, PTO unit 306, hydraulic power unit 308, brakes 310 and auxiliary unit 312 are described above. In the particular example illustrated, PTO unit 306 comprises a power take off 623 (shown in FIG. 10). In the example illustrated, lights 300 comprise hood lights 624 and roof lights 626.

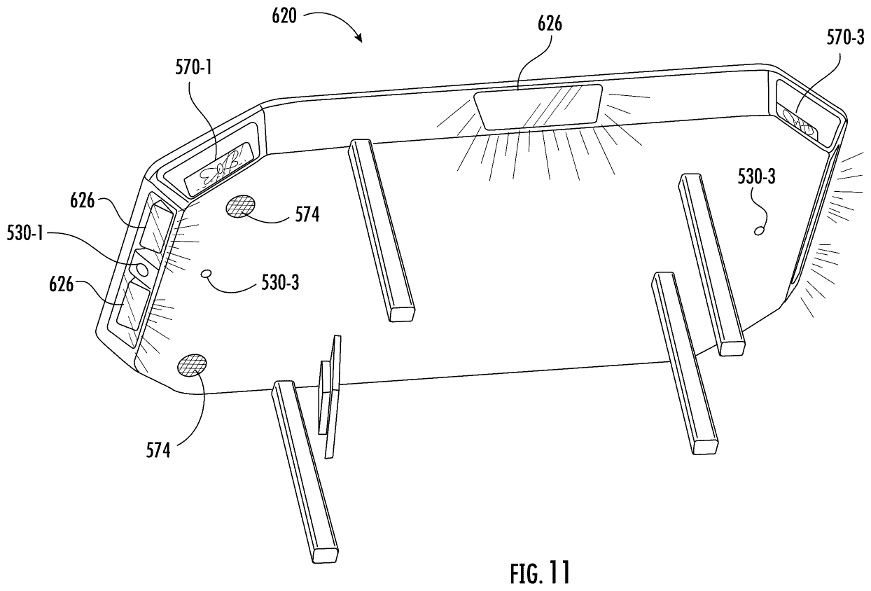

As with vehicle 224, vehicle 524 include sensors that capture the control gestures made by the operator 42. In the example illustrated, such sensors comprise cameras 530-1 (shown in FIG. 5), 530-2 (shown in FIGS. 6) and 530-3 (shown in FIG. 11) (collectively referred to as cameras 530). Cameras 530 capture images of operator control gestures as well as the surrounding environment and output signals to processor 32. Camera 530-1 extends on a front edge of roof 620 to capture regions in front of vehicle 524. Camera 530-2 extends on a rear edge of roof 620 to capture images of regions rearward of vehicle 524. Cameras 530-3 extend on underside of roof 620 to capture side regions of vehicle 524. Such cameras output signals identifying the location of the operator 42. In some implementations, vehicle 524 may include additional or fewer cameras at the same or different locations and alternative forms of sensors.

Vehicle state and feedback system 525 comprises indicators 570-1, 570-2, 570-3, 570-4 (collectively referred to as indicators 570), indicator 572, indicator 574, and state/feedback instructions 568. Indicators 570 comprise display screens located at the four corners of roof 620. Indicators 570-1 and 570-2 face in a forward direction and are angled towards their respective opposite sides of vehicle 524. Indicators 570-3 and 570-4 face in a rearward direction and are angled towards their respective opposite sides of vehicle 524. Indicators 570 present graphics and text which may be viewed by the operator 42 at various positions about vehicle 524.

Indicator 572 comprises an elongate bar or strip that wraps around a front of the hood 601 and the sides of hood 601 of vehicle 524, wherein the bar or strip may be selectively illuminated under the control of processor 32. In some implementations, indicator 572 is actuated between an illuminated and a non-illuminated state to provide feedback to the operator 42 who may be remote from vehicle 524, not within cab 606. In some implementations, indicator 572 was actuatable between different colors or shades of colors to provide status information to operator 42. In some implementations, indicator 572 is actuatable between different brightness levels or is actuatable so as to flash or flash at different frequencies to provide status information to operator 42.

Indicators 574 comprise speakers/microphones. In the example illustrated, indicators 574 are located on underside of roof 620 proximate steering console 618. Indicators 574 provide audible status information to an operator remote from vehicle 524. In some implementations in which indicators 574 also serve as microphones, indicators 574 may serve as input devices for the remote operator, whereby the operator may provide audible instructions or commands and wherein processor 32 uses speech recognition to identify such commands and carry out such commands.

In some implementations, lights 526 may serve as additional indicators, wherein a color, brightness, blinking frequency, or the like of such lights 526 may be controlled to provide status information to the operator 42. In some implementations, additional visible indicators, such as light emitting diode lights, light bars or the like may be utilized to provide status information based upon the current state of vehicle 524, its implements 225, its components 300, 302, 304, 306, 308, 310, 312 and/or the positioning of operator 42 or the positioning of implement 225 as based upon images captured by cameras 530.

State/feedback instructions 568 comprise software, code or logic elements on a circuit board provided in the non-transitory computer-readable medium 540. Instructions 568 direct processor 32 to output various control signals controlling the actuation or state of indicators 570, 572 and 574. For example, processor 32, following instructions 568, may indicate a first state of vehicle 524 by providing indicator 572 with a first brightness, color, on/off state and/or blinking frequency and may indicate a second different state of vehicle 524 by providing indicator 572 with a second different brightness, color, on/off state and/or blinking frequency. For example, indicator 572 may be illuminated to have a green color when traveling forward and illuminated to have a red color when stopped. By way of another example, indicator 572 may be illuminated to have a green color when the power takeoff is operating or when an implement is being powered and may have a red color when the power takeoff is no longer operating or when an implement is no longer being powered or driven.

Processor 32, following instructions 568, may indicate a first state of vehicle 524 or second state of vehicle 524 by displaying graphics or text on one or multiples of indicators 570. Such status information provided by indicators 570, 572, and 574 may include the speed or rate at which the vehicle is traveling, the speed or state of an implement and/or the state of any of lights 300, steering unit 302, propulsion unit 304, PTO unit 308, brakes 310 and/or auxiliary unit 312. Such feedback or status information provided by indicators 570, 572 and 574 may include a confirmation of receipt or capture of gestures from the operator (either operator anatomy 44 and/or input device 248), a confirmation of recognition of such gestures, an indication that such commands are about to be executed, a request for the operator to repeat such gestures or to move so as to be more centrally located within the field of view of cameras 530 when providing such gestures, or an indication that the commands associated with such gestures will not be carried out given the current state of vehicle 524 or the operator's position relative to vehicle 524 and/or its implements. Different indicators may be utilized to provide different types of status information to the operator.

In one implementation, processor 32, following instructions contained in medium 540, utilizes images from camera 530-1 to identify the positioning of rows of plants and to output control signals to steering unit 302 and propulsion unit 304 to automatically drive vehicle 524 (and any attachment/implement 225) between and along the rows of plants (such as crop plants, trees and the like). In one implementation, processor 32, following instructions contained in medium 540, utilizes images from camera 530-1 to identify the positioning or location of operator 42 and the movement of operator 42. Processor 32, following the instructions contained in medium 540, may further block or allow other commands from operator 42 (based upon input gestures) based upon the position or movement of operator 42. In some implementations, processor 32, following instructions contained in medium 540, may output control signals causing propulsion unit 304 and steering unit 302 to move vehicle 524 so as to follow the movement of operator 42 at a preselected or operator selected distance. In some implementations, processor 32 may control propulsion unit 304 and brakes 310 to substantially match the speed at which the operator is moving. In some implementations, processor 32, following instructions contained in medium 540, may utilize images captured by any of cameras 530 to identify animals or other obstructions, wherein processor 32 outputs control signals to steering unit 302 and propulsion unit 304 to control the movement of vehicle 524 so as to avoid such animals or obstructions. In some implementations, processor 32 may utilize signals from any of cameras 530 to control the lighting provided by lights 624, 626. In some implementations, processor 32 may utilize the signals from any of cameras 530 and additional signals from a provided global positioning system to automatically, without operator intervention, drive vehicle 524 to and from a worksite or field, to or from a storage lot, shed, garage or the like (a home location) for vehicle 524 or to or from a charging site or location for charging battery 604.

In some implementations, processor 32 may utilize the identified positioning of operator 42 or of animals or other obstructions so as to control brakes 310, PTO unit 306, auxiliary unit 312 or attachment/implement 225. For example, in one circumstance, the attachment/implement 225 may comprise a sprayer spraying herbicides, insecticides, fungicides or the like. In response to the detection of the presence of an operator or animal, processor 32 may temporarily cease the movement of vehicle 524 and/or the spraying operation until the operator animal is a predefined distance from the vehicle 524 or its implement 225. In some implementations, processor 32 may automatically cease the operation of power take off 623 in response to images from cameras 530 indicating that the operator, another person, or an animal are within a predefined distance from the power take off 623. In some implementations, processor 32, following instructions contained in medium 540, may utilize images captured by any of cameras 530 (plus any other sensors provided on vehicle 524) to control the actuation of an attachment/implement 225. For example, processor 32 may identify the various locations of feed troughs and may control the actuation of an auger or other device of a pulled or attached implement 225 to unload feed at particular times and locations into the feed troughs. As a result, processor 32 facilitates the automation of tasks.

In some implementations, indicators 570 or 572 may provide information to an operator 42 in circumstances where the operator's current identified position would prevent him or her from viewing or determining such information. For example, an operator positioned at the front of vehicle 524 may be provided with information on indicators 570-1 or 570-2 about the state of an implement 225 at the rear of vehicle 524. An operator positioned at the rear of vehicle 524 or at one side of vehicle 524 may be provided with status information on selected indicators 570 about the state of an implement, another operator or environment at the front of vehicle 524 or at the other side of vehicle 524. As a result, system 520 provides an operator remote from vehicle 524 with information that may not otherwise be viewable given the operator's current position relative to vehicle 524.

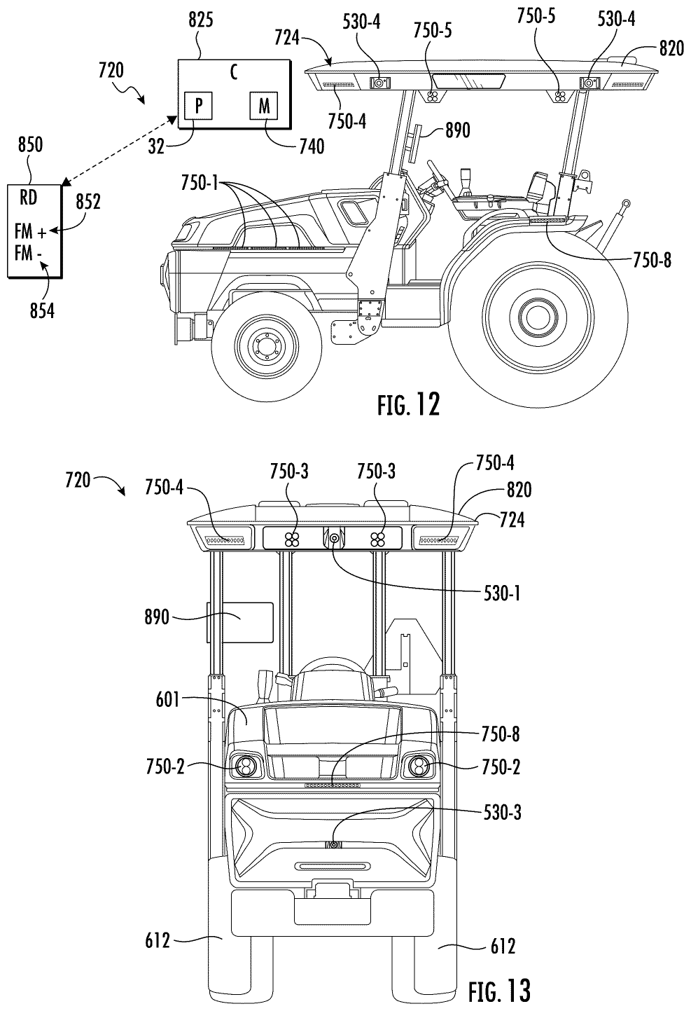

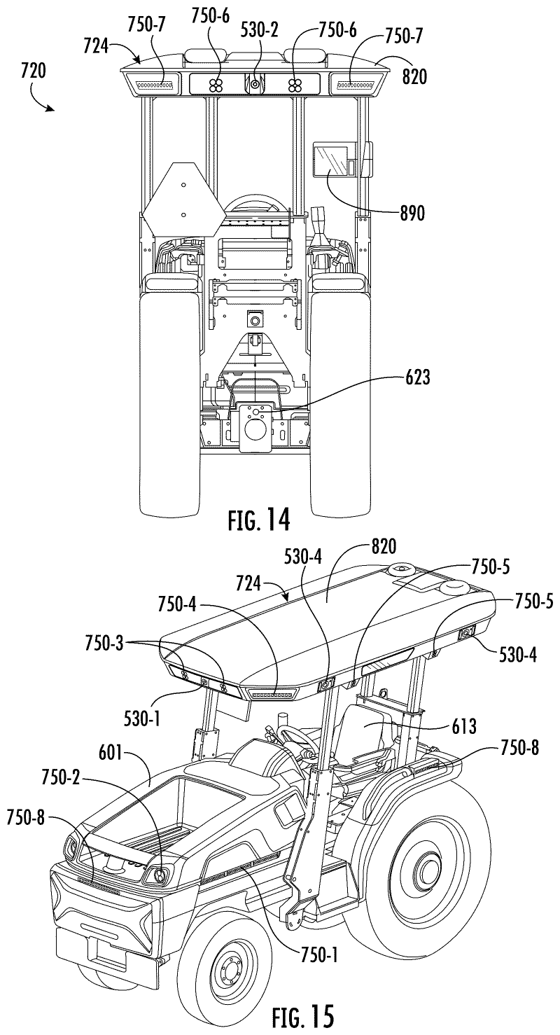

FIGS. 12-15 illustrate portions of an example vehicle control system 720 (also referred to as a zone control system) for a vehicle 724 in the form of a tractor. Vehicle 724 is similar to vehicle 624 described above. Vehicle 724 comprises cameras supported by roof 820 that have collective fields of view that, as described below, capture or sense 360° around vehicle 724, the regions including a safe zone, a searching zone, a locked zone and a chasing zone. In the example illustrated, vehicle 724 comprises cameras 530-1 and 530-2 (described above). Vehicle 724 further comprises camera 530-3 supported on the front of hood 601 at a height below the top of wheel 612. In the example illustrated, vehicle 724 may additionally comprise cameras 530-4 situated on opposite transverse sides of roof 820 alongside lights 750-5. Cameras 530-4 have field-of-view that encompass the lateral sides of vehicle 724. In such implementations, the field of views provided by cameras 530-1, 530-2, 530-3 and 530-4 (collectively referred to as cameras 530) provide a continuous field-of-view 360° about vehicle 724. In other implementations, vehicle 724 may include additional or fewer cameras situated about vehicle 724. In some implementations, such cameras may not have a combined field of view 360° about vehicle 724 and may not necessarily capture a search zone, but one or both of front ward and rearward zones.

In the example illustrated, vehicle 724 further comprises an operator interface 890 in the form of a touchscreen monitor. Interface 890 may present information to an onboard operator such as a current state of vehicle 724. Interface 890 may further receive operator input. For example, interface 890 may comprise a touchscreen or monitor presenting prompts for the input information or input of commands or selections. Such selections may be made by manual touch of the screen or by use of a joystick or mouse. In some implementations, operator interface 890 may further comprise a speaker for providing audible information or alerts and a microphone for receiving voice commands. In other implementations, operator interface 890 may have other forms such as a touchpad, mouse, joystick, display screen, monitor, lever, slide bar, pushbutton or the like.

Vehicle 724 further comprises multiple lights 750-1, 750-2, 750-3, 750-4, 750-5, 750-6, 750-7 and 750-8 (collectively referred to as lights 750) positioned about vehicle 724. Such lights provide illumination for cameras and light to enhance division of an operator. Such lights may further be actuated to different flashing states, colors and the like to provide notifications to those about vehicle 724 such as the current state of system 720 or when a person may be within a detection zone, a safe zone, a chasing zone, a locked zone or a searching zone.

In the example illustrated, lights 750-1 are located along opposite sides of front hood 601. Lights 750-1 comprise light bars that extend along a majority of the longitudinal length of hood 601. Lights 750-2 are supported by hood 601 along the front of vehicle 724 (in the form of a tractor). Lights 750-3 are supported by on the exterior of the roof 620 of the operator cab and face in a forward direction. Lights 750-4 are located on and supported by the roof of the operator cab in the front right and front left corners of the roof 820, facing approximately 45° from either side of the longitudinal centerline of vehicle 724. Lights 750-5 are located on the lateral or transverse exterior sides of the operator cab roof. Lights 750-6 are similar to lights 750-3, but face in a rearward direction. Lights 750-6 are on the rear exterior edge or side of the operator cab roof 820. Lights 750-7 are similar to lights 750-4 but are supported on the rear exterior edge or surface of roof 620 and face in directions offset 45° from the longitudinal centerline of vehicle 724. Lights 750-8 comprise lights supported along the rear transverse sides of vehicle 724 above the rear tires of vehicle 724, and on the front of hood 601, below lights 750-2. In the example illustrated, lights 750-8 are supported on exterior upper surfaces of the rear tire fenders or fender wells of vehicle 724.

Vehicle 724 comprises a controller 825 which comprises processor 32 and medium 740. Medium 740 is similar to medium 40 or medium 540 described above. Medium 740 may comprise a non-transitory computer-readable medium containing instructions configured to direct processor 32 to operate in a safe mode or a follow mode (sometimes referred to as a follow me mode) as described hereafter.

As schematically shown by FIG. 12, system 720 may additionally comprise a portable remote device 850 which is in wireless communication with controller 825. Portable remote device (RD) 850 may be in the form of a tablet computing device, a laptop computer, a smart phone or a particular dedicated remote device for use with system 720. In implementations where system 725 offers a follow mode, remote device 850 may be configured to present prompts or other means by which a remote operator, residing on the ground offboard from vehicle 724, may provide offboard follow mode (FM) entry request input 852 (FM+) and an offboard FM exit request input 854 (FM−). As will be described hereafter with respect to method 1000, the use of remote device 850 to provide controller 825 with a follow mode entry or exit specific request may serve as a further confirmation or checkpoint to avoid unintended entry or exit into or from the follow mode. As will be described hereafter, in some implementations, portable remote device 850 may be omitted where the follow mode entry and/or exit commands are communicated to controller 825 in other fashions, such as with anatomical gestures (such as a hand gesture) by the remote operator that are captured by a camera of vehicle 724 and that are recognized by controller 825 as a particular FM exit or entry command.

In some implementations, device 850 may emit a signal that may be utilized by system 720 to estimate the current positioning of the remote device 850 relative to vehicle 724, wherein system 720 may then determine the current positioning of the operator relative to vehicle 724. System 720 may utilize this capability in place of relying upon cameras 530 to determine the current positioning of the remote operator or may be used in combination with the images captured by one or more of cameras 530 to determine the current positioning of the remote operator. For example, remote device 850 may include a global positioning satellite (GPS) locator, wherein vehicle 724 also includes a GPS locator, permitting controller 825 to determine the relative positioning of the remote device 850 (and the remote operator carrying the remote device 850) relative to vehicle 724. As will be described hereafter with respect to the follow mode entry and exit, system 720 and controller 825 may utilize the GPS locators to determine whether the remote operator is within a particular zone. In addition, in some implementations, system 720 may alternatively or additionally utilize the GPS determined relative positioning of the remote operator (steering remote device 850) and vehicle 724 to control the vehicle 724 so as to follow the remote operator. In some implementations, such GPS signals from the two GPS antenna or locators may be utilized by controller 825 in lieu of reliance upon cameras 530 to follow the remote operator when in a follow mode.

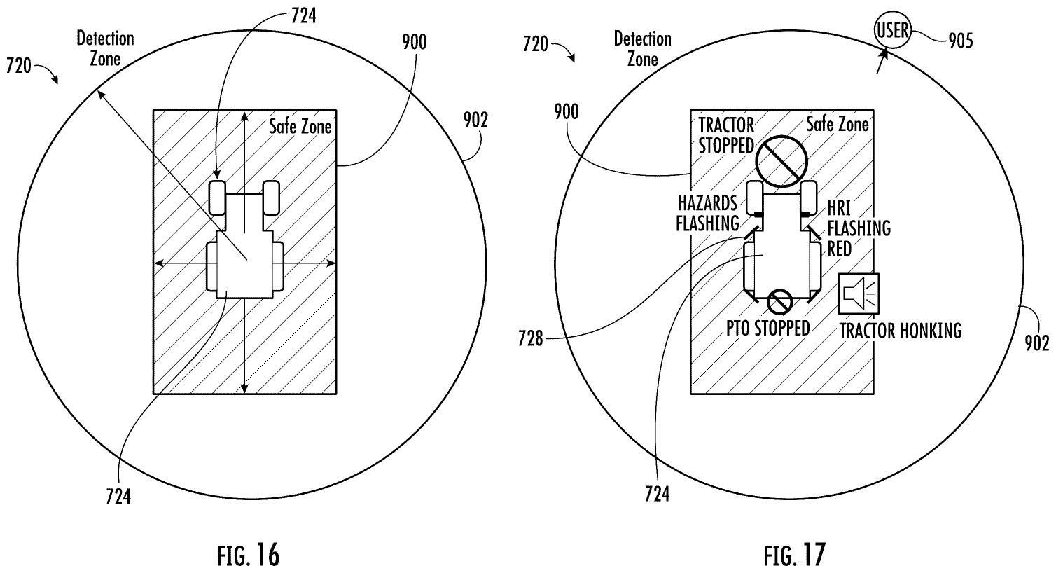

FIGS. 16-19 illustrate vehicle 724 with controller 825 operating in a “safe mode”. FIGS. 16-19 illustrate example detection zones and safe zones for vehicle 724. In other implementations, such safe zones and detection zones may have other distances and locations. As described with respect to FIGS. 16-19, in response to a user/person identified within the detection zone, controller 825 automatically carries out certain preventive or safe measures by automatically outputting control signals that cause lights L to emit light in a particular fashion, notifying the user and the operator of the detection of a user within the detection zone. Such notification may further be carried out by “honk flashing”, repeated honks from an auditory emitter of vehicle 724. In addition, such control signals may further adjust or control functions of vehicle 724, such as operation of its power takeoff, the speed or propulsion of vehicle 724 and the like. Such control signals may further actuate audible mechanisms for further notification of those about vehicle 724.

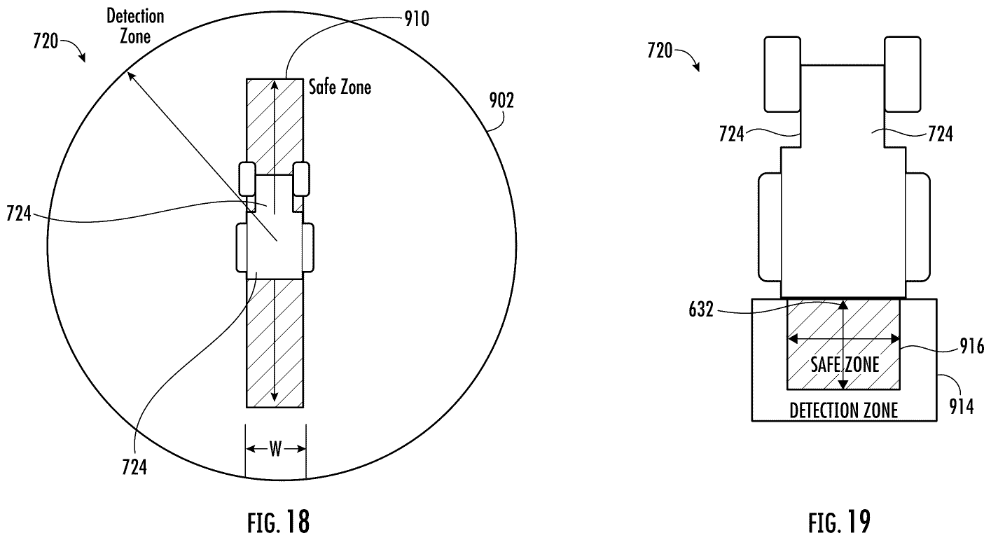

As further described with respect to FIGS. 16-19, different actions may occur in response to the user/operator being within a predefined “safe zone”. As shown by FIG. 19, in some implementations, the location and size of the safe zone and detection zone may vary depending upon whether or not vehicle 724 is moving, and the direction of travel of vehicle 724. The safe zones may further vary depending upon the operative state of vehicle 724. For example, when the PTO is currently being driven or powered, controller 825 may have a first particular predefined safe zone and a first particular predefined detection zone. When the power takeoff is not operating, the safe zone may have different dimensions or in some cases, may be omitted.

In the example illustrated, the predefined detection zone 902 encompasses the safe zone 900 and has a radius (from a center point of vehicle 724) of at least 9 meters and up to 11 meters, 360° about vehicle 724. In the example illustrated, the predefined safe zone 900 extends transversely to either transverse side of vehicle 724 by distance in the range of 2.5 meters to 3.5 meters and extends forwardly and rearwardly of vehicle 724 in the range of 4.5 meters to 5.5 meters. In other implementations, the safe zone may have other dimensions depending upon the vehicle. In some implementations, the forward extent of the safe zone 900 (the distance from the front of vehicle 724) may dynamically change during operation of vehicle 724 based upon the current forward speed of vehicle 724. Likewise, in some implementations, the rearward extent of the safe zone 900 may dynamically change. In some implementations, the size of a safe zone 900 changes based upon the current rearward speed of vehicle 724. In such implementations, controller 825 may evaluate the current speed of vehicle 724 and adjust the forward distance or extent of the safe zone 900 based upon the ascertained speed. In some implementations. dimensions or size of the safe zone 900 may be dynamically changed by controller 825 in response to or based upon the current operation being carried out by vehicle 724 and/or the size or type of implement or attachment being carried by vehicle 724 (in the form of a tractor).

During operation of vehicle 724, control 825 periodically or continuously monitor signals from cameras 530 detect the presence of an operator within the larger detection zone 902 which completely surrounds and encompasses safe zone 900. The detection zone 902 may be provided by the combined field of views of the multiple cameras 530. In response to controller 825 detecting and determining that an operator, other human or, in some implementations, an animal currently resides on the ground in detection zone, controller 825 may output control signals that cause the hazard lights on vehicle 724 to flash that cause one or more other lights, (such as HRI lights) to flash a particular color, such as orange.

In response to sensing, detecting and/are determining that an operator, other human (or animal) currently resides in the current safe zone, controller 825 may output control signals stopping vehicle 724, and stopping PTO 623. In addition, controller 852 may output control signals causing one or more of the light 750 to flash red and the hazards to flash. The control signals may further cause an auditory emitter to repeatedly honk on and off (“flashing”). In some implementations, a notification may further be presented on the screen of operator interface 890, providing a warning that an operator (or animal) may be in the safe zone.

FIG. 17 illustrates an example scenario where the operator 905 has left or is no longer residing in either of the safe zone 900 or the detection zone 902. As result, controller 825 may output signals causing the tractor to resume motion in response to subsequently received hand or foot throttle parameters. In addition, the controller 825 may cause the at least one of lights 750 to stop flashing, the hazards to stop flashing and the honk flashing to be stopped. In circumstances where power takeoff 632 was active prior to automatic stopping caused by the entry of the tractor into the safe mode, the PTO 632 may remain stopped. In such an instance, control 825 may output control signals causing the operator interface 890 to display a pop-up indicating that the PTO is stopped due to the safe mode stop and that the PTO may be restarted using the PTO lever or other controls. In some implementations, controller 825 requires that the operator (onboard) apply force to the foot brakes, whereupon release the brake, the tractor (vehicle 724) resumes motion. In other implementations, other onboard operator input may be utilized to resume tractor motion upon exiting of the safe mode which occurs in response to controller 825 determining that the operator 905 is no longer within the detection zone 902 based on signals from one or more of cameras 530.

As shown by FIG. 18, in some implementations, system 720 may have different safe zones, a first safe zone for humans and a second different safe zone for other non-human bodies such as animals, other tractor implemenst, walls, rocks and the like. In the example illustrated, system 720 comprises a non-human safe zone 910. Safe zone 910 extends forwardly and rearwardly of vehicle 724 and has a width W that is based upon, that is proportional to or that otherwise corresponds to the width of vehicle 724.

In some implementations where vehicle 724 is pulling, pushing or carrying an implement or attachment, the width W may be based upon or corresponding to the width of the implement or attachment. In implementations where the implement or attachment itself is actuatable between different states having different widths, the width W of safe zone 902 may correspond to the particular width of the implement or attachment in the current state of the implement are attachment. For example, an implement or attachment have booms or wings which are extendable or retractable, wherein the width W of the safe zone 910 may be based upon width of the current extended or current retracted booms or wings. In such implementations controller 825 may determine the current width or current state of the implement or attachment based on signals from one or more of cameras 530. In yet other implementations, control 825 may determine the current with the current state of the implement or attachment based upon operator input or stored parameters and whether or not controller 825 has received commands or inputs causing a particular state for the implement or attachment. After determining the state of the implement or attachment and its width, controller 25 may then calculate or otherwise determined or retrieved a corresponding width W (from a remote server or a look up table) for the safe zone 910.

In one example implementation, the detection zone may have a radius of at least 6 meters and up to 8 meters 360 degrees about vehicle 724. In some implementations, the safe zone may extend at least meters and up to 6 meters in front of vehicle 724 and at least 4 meters and up to 6 meters rearward of the rear end of vehicle 724. In other implementations, the detection zone 902 and the safe zone 910 may have other shapes as well as other dimensions. As with safe zone 900, in some implementations, the forward and/or rearward extent of safe zone 910 may automatically be adjusted by controller 825 depending upon the current speed of vehicle 724 are the current operative state of vehicle 724.

In response to an object (animal, tractor, walls, rocks or the like) being detected within the safe zone 910, controller 825 may output control signals causing one or more of lights 750 to change operative state. For example, the control signals may cause the one or more of light 750 to flash a particular color, such as orange. Likewise, a pop-up warning may be presented by controller 825 on the display of operator interface 890. In some implementations, the forward or rearward movement of vehicle 724 may automatically slow down or stop. In some implementations, the forward or rearward may not slow down in circumstances where the benefit of slowing down is outweighed by impact on the operator experience, such as when vehicle 724 is being operated in a narrow or dense environment.

In some implementations, system 720 may be switchable between a first safe mode as shown and described above with respect to FIG. 16, a second safe mode as shown and described above with respect to FIG. 18 and a third safe mode as shown in described with respect to FIG. 19. In some implementations, system 720 may automatically enter the safe mode shown in FIG. 19 in response to the PTO 632 being turned on. The safe mode shown in FIG. 19 may be selected by an operator when vehicle 724 is no longer moving or stopped. The safe mode shown in FIG. 19 may be utilized as a safe measure for the rear PTO 632.

In the example illustrated, controller 825 determines, retrieves otherwise establishes a rear detection zone 914 and the rear safe zone 916. Detection zone 914 extends rearward of vehicle 724. In one implementation, the zone 914 has a width corresponding to a width of vehicle 724. In one implementation, detection zone 914 has a width of at least 2.7 meters and up to 3.3 meters, and a longitudinal length of at least 1.7 meters and up to 2.3 meters. In the example illustrated, zone 914 is generally centered about the PTO 632.

In response to determining that an operator is currently residing within the detection zone 914, based upon signals from a rearward facing camera, such as camera 530-2, controller 825 may output control signals causing one or more of the lights 750 to change operative state, brightness, color, frequency of the like (such as flashing the color orange). Controller 825 may further cause the auditory emitter to repeatedly honk on and off (flashing) and may cause a hazard lights also flash. In some implementations, a notice may be presented on the display operator interface 890 or may be emitted by a speaker (audible alert words) associated interface 890.

Safe zone 916 is at least partially contained within and encompassed by detection zone 914. In the example illustrated, safe zone 916 has a width and a longitudinal rearward length less than that of detection zone 914. Safe zone 916 extends from the rear of vehicle 724. In the example illustrated, safe zone 916 has a width of at least 2.7 meters and up to 2.3 meters, centered along PTO 632. Safe zone 916 has a longitudinal length of at least 2 meters and up to 2.3 meters extending from or beyond the tip of the PTO 632.

In response to determining that an operator or other human is currently residing in the safe zone 916 based upon signals from a sensor or camera, such as camera 530-2, controller 825 may output control signals in automatically stopping the PTO, braking the PTO. In addition, controller 85 may output control signals causing at least one of lighst 750 to change in operative state, for example, change to a flashing red color. In addition, such control signals may cause an audible emitter to begin honk “flashing”. In such implementations, the honk flashing may be at a greater frequency or greater volume as compared to when humans merely detected within detection zone 914. In some implementations at different sound may be omitted when an operator is attacked within safe zone 916 as compared to when an operator is detected within detection zone 914. Upon determining that an operator or other human is no longer within the safe zone or the detection zone, controller 825 may present a notification on operator interfacing 90 that operation may be resumed through further operator input, such as resetting a PTO lever.

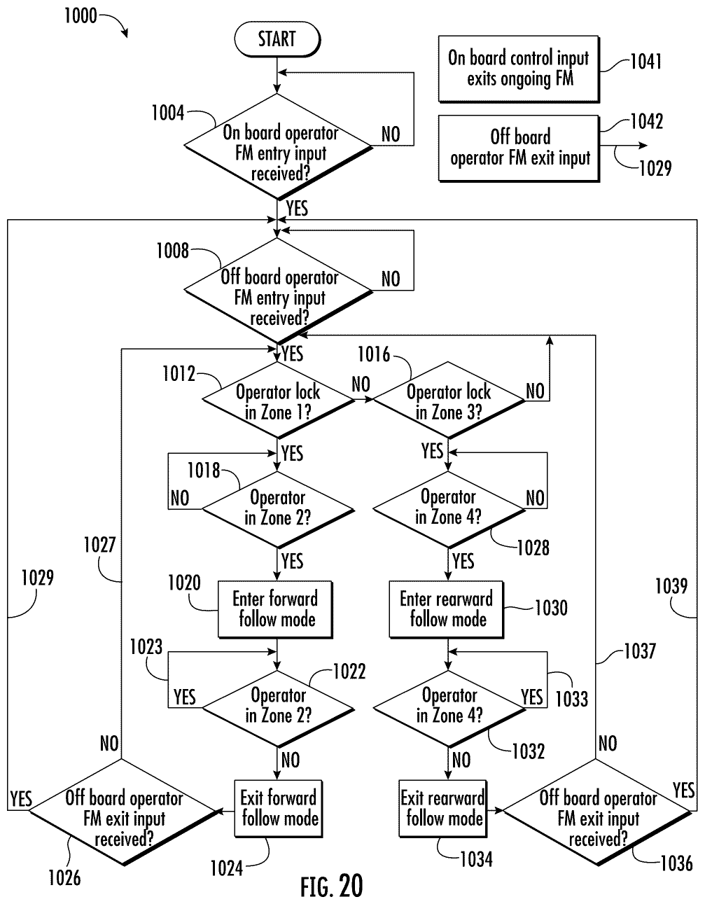

FIG. 20 is a flow diagram of an example method 1000 that may be carried out by controller 825 of system 720. Method 1000 is a method for entering and exiting a follow me or follow mode where system 720 control of vehicle 724 such a vehicle 724 tracks and follows an operator on the ground, no longer residing on vehicle 724.

When operating pursuant to method 1000, controller 825 automatically enters and exits a follow mode at least partially based upon the current location of an authorized operator of vehicle 724. When in the follow mode, controller 825 tracks the movement of a remote operator. When in the follow mode, controller 25 further outputs control signals that control the steering and/or propulsion of vehicle 724 such that the vehicle 724 (a tractor) follows the tracked operator.

In some implementations, vehicle 724 may follow the tracked operator as a tractor remote operator moves ahead of or forward vehicle 724 in a forward direction (a forward follow mode). In some implementations, vehicle 724 may follow the tracked operator as a remote operator moves behind and in a rearward direction away from a rear of the vehicle (a rearward follow mode). In some implementations, controller 825 may perform both a forward follow mode and a rearward follow mode.

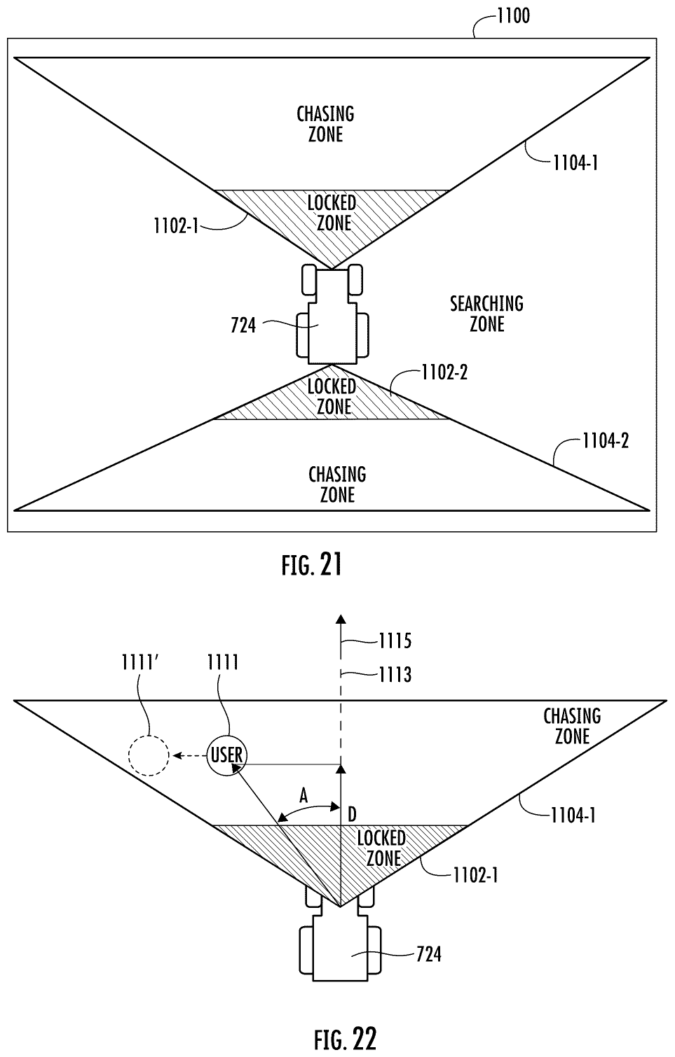

FIG. 21 illustrates an example set or plurality of predefined zones that may be utilized by controller 825 in carrying out method 1000. In the example illustrated, system 20 utilizes stored zones 1100, 1102-1, 1102-2 (collectively referred to as zones 1102), 1104-1 and 1104-2 (collectively referred to as zones 1104). Zones 1100, 1102 and 1104 may be stored locally in memory 740 or remotely, controller 25 may retrieve such zones from a central server or the like in a wireless fashion. Zones 1100, 1102 1104 are regions defined by relative distances with respect to vehicle 724, irrespective of the geographic coordinates of vehicle 724.

Zone 1100 comprises zone 1100 is a region about vehicle 724 which may be viewed using cameras carried by vehicle 724. Zone 1100 encompasses zones 1102 and 1104. In some implementations, zone 1100 may have other shapes and relative sizes, or may be omitted.

Zones 1102 comprise “locked” zones, regions in which a remote operator (an offboard operator) may be locked onto for tracking as part of a follow mode. Zone 1102-1 is a zone forward of vehicle 724 which may be utilized as part of method 1000 for entering a forward follow mode, a mode in which the tractor is propelled in a forward direction to follow the remote tracked operator. Zone 1102-2 is a zone rearward of vehicle 724 which may be utilized as part of method 1000 for entering a rearward follow mode, a mode in which the tractor is propelled or driven in a rearward direction to file the remote tracked operator.

In the example illustrated, zones 1102-1 and 1102-2 are triangular in shape, corresponding to or contained within the field-of-view of cameras 530-1 and 530-2, respectively. In other implementations, zones 1100 may have different sizes and different shapes. In some implementations, zones 1101 and 1104 may be at other locations relative to vehicle 72, such as at a particular side location with respect to vehicle 724. In implementations where only a forward follow mode is offered, zone 1102-2 may be omitted. Likewise, in implementations where only a rearward follow mode is offered, zone 1102-1 may be omitted.

Zones 1104, sometimes referred to as “chasing” zones, comprise regions relative to vehicle 724 where the presence of a remote operator will cause vehicle 724 to enter into (presuming other safety triggers have been realized) or remain in an ongoing follow mode. Zone 1104-1 extends forward from zone 1102-1 while zone 1104-2 extends rearwardly from zone 1102-2. In the example illustrated, each of zones 1104-1 and 1104-2 are wider than their respective zones 1102-1 and 1102-2. In the example illustrated, each of zones 1104-1, 1104-2 is trapezoidal in shape, widening away from zones 1102-1, 1102-2, respectively.

In other implementations, system 720 may utilize a greater number of zones. Zones may have different shapes and relative sizes as well as different locations. In some implementations, the relative size and/or shape of the zones 1102, 1104 may vary depending upon the current operation being performed or to be performed by vehicle 724 and/or the current speed of vehicle 724 (impacting the shape and size or size of zones 1104). In such implementations, system 720 may include a lookup table or similar arrangement containing differently configured zones 1102, 1104 for different operational states or vehicle speeds, wherein control 825 uses a current or immediately forthcoming operational state or speed of vehicle 724 to determine which of the predetermined chasing zones 1102, 1104 are to be employed with method 1000. In some implementations, the shape and/or dimensions of the particular zones 1102 and/or 1104 may be calculated by controller 825 based upon a formula, wherein the current operation and speed of vehicle 724 factor into the formula. In some implementations, the operator may be given an opportunity on interface 890 or otherwise to establish or adjust a predefined or recommended/default shape and size of zones 1102, 1104. In some implementations, the shape and size of the chasing zone may also vary depending upon the type or size of implement or attachment being pushed, pulled or operated by vehicle 724, or the environment in which vehicle 724 is operating, such as the spacing between consecutive plant or crop rows.

As indicated above, controller 825 automatically exits and enters a follow mode at least partially based upon the current location of the remote operator with respect to a plurality of predefined zones. Controller 825 analyzes images captured by cameras 530 to determine the current location of the remote operator relative to the predefined zones. In some implementations, controller 825 may determine the current location of the operator in other fashions example, in some implementations, the operator may carry smart phone or other portable device, the location of which may be tracked by one or more sensors carried by vehicle 724 and in communication with controller 825. For example, an operator may carry a smart phone or a separate portable electronic device having a Bluetooth or other wireless transmission capability, wherein control 825 utilizes Bluetooth or other wireless signal to determine the location of the operator relative to vehicle 724 and relative to the predefined zones. In some implementations, vehicle 724 may include other sensing devices, such as light detection and ranging (LIDAR) sensors to determine the relative positioning the operator with respect to vehicle 724 and/or the predefined zones. As described above, in some implementations the remote device 850 may comprise a GPS locator, wherein the vehicle 724 also comprise a GPS locator, wherein signals from the two GPS locators may be utilized to determine whether the remote operator (carrying the remote device 850) current resides in a particular zone.

As shown by FIG. 20, method 1000 begins at an initial state where vehicle 724 is not in a follow mode, such as where vehicle 724 may be controlled by an operator onboard vehicle 724 or may be under direct remote control by a remote operator. At such times, controller 825 awaits further input from an operator as part of the process for initiating or entering a follow mode.

As indicated by block 1004 in FIG. 20, controller 825 determines whether an onboard operator follow mode (FM) entry input has been received. For purposes of this disclosure, the term “on board” means that the operator is on vehicle 724, such as within the cab of vehicle 724, when the input is provided. In the example illustrated, the onboard operator FM entry input may be received by operator interface 890 or in other pushbutton or input device accessible to the operator when the operator is seated on the vehicle 724. As will be evident below, input of the onboard operator FM entry request does not, in itself, trigger entry into the follow mode. In some implementations, controller 825 may present a prompt for the entry of the FM entry request or it may be provided as a graphical user interface presented on the screen as part of a menu or scroll down. As indicated by 1041, at any time, an operator may provide an onboard control input to vehicle 724, such as turning the steering wheel, applying the brake, changing the throttle RPM or the like) which automatically causes system 720 to exit the initial steps towards entering the follow mode. In other words, the operator must reenter the onboard operator FM entry request in block 1004 to begin the method 1000 again. In some implementations, method 1000 may omit block 1004, wherein the monitoring and blocks 1012 and 1016 is initiated solely in response to an offboard operator FM entry request input being received (block 1008).

As indicated by block 1008, upon receiving the onboard operator FM entry request input, controller 825 begins looking for or awaits an offboard operator FM entry input. An offboard operator FM entry request input is one that is received by the operator after the operator has exited vehicle 724 and no longer resides on vehicle 724. Such input received from the operator while the operator is residing on the ground outside vehicle 724. In other words, the operator is a remote operator.

In some implementations, the offboard operator FM entry request may be input using a portable or handheld wireless communication device which is in communication with controller 825. For example, in some implementations, the offboard operator FM entry request may be input on a tablet computer, laptop computer or smart phone carried by now remote operator. A prompt may be provided on the portable electronic device or the operator may access a graphical user interface (potentially as part of a scroll down menu) to touch or otherwise select.

In some implementations, the offboard operator FM entry request may be input through particular predefined anatomical gestures by the remote operator which are caught or captured by at least one of cameras 530 on vehicle 724. For example, the remote operator may make a particular hand gesture within the field-of-view of at least one of cameras 530. Controller 825 may be configured to receive images from the camera and analyze such images to ascertain whether the images contain a predefined hand gesture that corresponds to or that is assigned to an offboard operator FM entry request.

Upon determining that an image contains the predefined hand gesture corresponding to the offboard operator FM entry request, control 825 deems the entry request is being made. During this process, controller 25 may output control signals causing at least one of light 750 or an auditory emitting device to change state (change color, light on-off, flashing frequency, honking or the like) to confirm to the remote operator that his or her offboard request for the follow mode entry has been recognized and received.

As indicated by blocks 1012 and 1016, upon controller 825 receiving both the onboard operator FM entry request input and the offboard operator FM entry request input, controller 825 begins to monitor images received from cameras 530 to determine whether the remote operator has entered either of zones 1102. Zones 1102-1 and 1102-2 serve as zones 1 and zone 3, respectively, in method 1000. Such monitoring may occur on a periodic basis or a continual basis. As noted above, zones 1102 constitute regions about vehicle 724 where system 720 may “lock” onto the remote operator. Such locking when 720 obtain sufficient visual information regarding the remote operator to enable system 722 track movement of the remote operator.

In some implementations, system 720 may have stored authorization data identifying particular remote operators as being authorized to request and utilize the follow mode in system 720. In such implementations, such locking may also involve controller 825 verifying that the remote operator within zone one or zone 3 satisfies a stored authorization before proceeding with potentially entering the follow mode. In some implementations, controller 825 verifies the authorization by comparing the image of the remote operator to pre-images of those individuals authorized. In some implementations, system 720 may additionally require that the remote operator fight a particular anatomical gesture, such as pickle hand gesture, to further authorize the individual as an authorized remote operator for using follow mode.

As indicated by block 1018, once the remote operator has been locked upon in block 1012 when residing in zone 1 (zone 1102-1), controller 825 begins to look for the presence of the remote “locked” operator in zone 2 (zone 1104-1). This monitoring may occur in a periodic or continuous fashion. In the example illustrated, controller 825 monitors a stream of video or images from at least camera 503-1. As described, in other implementations, controller 825 may determine the presence of a remote operator in a particular zone in other fashions. As indicated by block 1020, upon determining that the remote operator is currently within the chasing zone 1104-1 (zone 2), controller 825 enters the forward follow mode. As described above, in the forward follow mode, controller 825 outputs control signals controlling the propulsion and/or steering of vehicle 724 to “follow” the tracked remote operator moving within the chasing zone.

As indicated by block 1022, once in the forward follow mode, controller 25 continues to monitor or determine whether the remote operator remains within zone 2 (the chasing zone 1104-1). As indicated above, the chasing zone is relative to the current position of vehicle 724. Thus, as vehicle 724 is moving forward, the chasing zone is also moving forward. As vehicle 724 moves left to right (laterally) the chasing zone is also proportionally moved from left to right. Such monitoring may occur on a periodic basis or in a continuous fashion. As described above, such monitoring may be achieved by controller 825 analyzing stream of video or images from camera 530-1. Such monitoring may be achieved in other fashions as well, such as with LiDAR or tracking devices carried by the remote operator. As indicated by arrow 1023, system 720 remains in the forward follow mode until a determination is made that remote operator no longer currently resides within the chasing zone 1104-1.

As indicated by block 1024, in response to a determination that the remote operator is no longer within the chasing zone 1104-1, system 720 automatically exits the forward follow mode. In one implementation, controller 825 exits the forward follow mode by outputting control signals causing vehicle stop moving forward. At such times, controller 825 may output control signals causing lighter auditory devices of vehicle 7242 change state so as to notify the remote operator that he or she is no longer being tracked or followed, that system 720 has exited the forward follow mode.

As indicated by block 1026, upon exiting the forward follow mode, controller 825 begins to monitor or await receipt of an offboard operator FM exit request input. This input may be provided by the remote operator in a fashion similar to the manner in which the offboard operator FM entry request input was provided in block 1008. For example, the operator may access a portable electronic device (such as a portable tablet computer, laptop computer or smart phone) that is in wireless communication with controller 825 and provided command or request that the forward follow mode be exited. In some implementations, the operator may make an anatomical gesture, such as a hand gesture that is captured by one of cameras 530, wherein controller 825 analyzing stream of images, recognizes the gesture and associates the gesture with a command to exit the forward follow mode. As indicated by arrow 1027, until controller 825 receives an offboard operator FM exit request input, controller 825 returns to block 1012, once again looking for the operator to return to either of zones 1102 four once again being locked and for once again potentially entering the forward follow mode or the rearward follow mode. Controller 825 continues to look for the operator reentering either of zones 1102 until controller 825 receives the offboard operator FM exit request input.

As indicated by arrow 1029, upon receiving the offboard operator FM exit request input, controller 825 returns to block 1008. At such times, the operator may reenter either of zones 1102 without such a location potentially triggering entry into a follow mode. To reenter the forward follow mode, the operator must once again provide the offboard operator FM entry request input in block 1008 then satisfy the criteria in the subsequent blocks outlined in FIG. 20.

As indicated by block 1028, once the remote operator has been locked upon in block 1016 when residing in zone 3 (zone 1102-2), controller 825 begins to look for the presence of the remote “lock” operator in zone 4 (zone 1104-2). This monitoring may occur in a periodic or continuous fashion. In the example illustrated, controller 825 monitors a stream of video or images from at least camera 503-2. As described, in other implementations, controller 825 may determine the presence of a remote operator in a particular zone in other fashions. As indicated by block 1030, upon determining that the remote operator is currently within the chasing zone 1104-2 (zone 4), controller 825 enters the rearward follow mode. As described above, in the rearward follow mode, controller 825 outputs control signals controlling the propulsion and/or steering of vehicle 724 to “follow” the tract remote operator moving within the chasing zone 1104-2.

As indicated by block 1032, once in the rearward follow mode, controller 825 continues to monitor or determine whether the remote operator remains within zone 4 (the chasing zone 1104-2). As indicated above, the chasing zone is relative to the current position of vehicle 724. Thus, as vehicle 724 is moving forward, the chasing zone is also moving forward. Such monitoring may occur on a periodic basis or in a continuous fashion. As described above, such monitoring may be achieved by controller 825 analyzing video stream or stream of images from camera 530-2. Such monitoring may be achieved in other fashions as well, such as with LiDAR or tracking devices carried by the remote operator. As indicated by arrow 1033, system 720 remains in the rearward follow mode until a determination is made by controller 825 that remote operator no longer currently resides within the chasing zone 1104-2. In other words, controller 825 will continue to monitor and track the current position of the remote operator and output control signals causing vehicle 724 to follow the tracked remote operator. When the remote operator stops, the propulsion of vehicle 724 stops. When the operator begins to move, vehicle 724 begins to move (proportionally or disproportionately or begins to move (proportionally or disproportionally) after a slight delay due to processing time or as established by the settings of system 720.

As indicated by block 1034, in response to a determination that the remote operator is no longer within the chasing zone 1104-2, system 720 automatically exits the rearward follow mode. In one implementation, controller 825 exits the rearward follow mode by outputting control signals causing vehicle 724 to stop moving in a rearward direction. At such time, controller 825 may output control signals causing light or auditory devices of vehicle 724 to change state so as to notify the remote operator that he or she is no longer being tracked or followed, that system 720 has exited the rearward follow mode. As indicated by block 1036, upon exiting the rearward follow mode, controller 825 begins to monitor or await receipt of an offboard operator FM exit request input. This input may be provided by the remote operator in a fashion similar to the manner in which the offboard operator FM entry request input was provided in block 1008. For example, the operator may access a portable electronic device (such as a portable tablet, laptop computer or smart phone) that is in wireless communication with controller 825 and provided command or request that the forward follow mode be exited. In some implementations, the operator may make an anatomical gesture, such as a hand gesture that is captured by one of cameras 530, wherein controller 825 analyzing stream of images, recognizes the gesture and associates the gesture with a command to exit the forward follow mode. As indicated by arrow 1037, until controller 825 receives an offboard operator FM exit request input, controller 825 returns to blocks 1012 and 1016, once again looking for the operator to return to either of zones 1102 for again being locked onto and for once again potentially entering the forward follow mode or the rearward follow mode. Controller 825 continues to look for the operator reentering either of zones 1102 until controller 825 receives the offboard operator FM exit request input.

As indicated by arrow 1039, upon receiving the offboard operator FM exit request input, controller 825 returns to block 1008. At such time, the operator may reenter either of zones 1102 without such a location potentially triggering entry into a follow mode. To reenter the forward follow mode, the operator must once again provide the offboard operator FM entry request input in block 1008 then satisfy the criteria in the subsequent blocks outlined in FIG. 20.

FIG. 22 illustrates vehicle 724 operating in a forward follow mode. FIG. 22 illustrates a remote operator 1111 who was locked while residing within zone 1102-1 and then moved to chasing zone 1104-1 which caused vehicle 724 to follow the remote operator 1111. FIG. 22 illustrates operator 1111 at a longitudinal distance D forward and relative to a predefined point on vehicle 724 (the front of the hood of the tractor or the location of the camera or other sensor detecting the location of the operator) and angularly spaced from the longitudinal centerline 1113 of vehicle 724 by an angle A. In some implementations, the control signals cause vehicle 724 to match both the speed and direction of the tracked operator. Said another way, controller 825 outputs control signals such that the propulsion or speed of vehicle 724 is proportional to the distance D. Controller 825 outputs are angular steering of vehicle 724 is also proportional to the angle A.

In some implementations, the control signals cause vehicle 724 to match the direction of movement of the tracked operator but move at a different speed than the operator. For example, in some implementations, controller 825 may cause vehicle 724 to travel at a greater speed, attempting to catch up to the tracked operator. In some implementations, controller 825 may cause vehicle 724 to travel at a slower speed, proportional to the speed of the movement of the tracked operator.

In some implementations, the control signals cause the vehicle 724 to maintain a straight or linear course and to maintain a predefined distance D relative to the tracked operator. For example, the remote operator may be permitted to move laterally relative to vehicle 724 to the new position 1111′ (changing angle A), such as laterally between a pair of rows 1116 in field, vineyard or orchard, wherein such lateral movement does not affect the course of the vehicle 724 (the steering of vehicle does not change); the vehicle 724 maintaining its generally straight or linear direction of travel (as indicated by arrow 1115) between and parallel to the pair of rows. Despite permitting the angle A between the operator and vehicle 724 to vary as the operator moves laterally between the pair of rows, controller 825 adjusts the propulsion or speed of vehicle 724 to maintain a predefined longitudinal distance D (without changing its direction along the currently depicted axis 1113 or arrow 1115 or linear direction of travel between the pair of rows) between vehicle 724 and the remote operator. In the example illustrated, the width of zone 1104-1 is preestablished so as to correspond to the lateral spacing (measured in a direction orthogonal to the center line parallel to and between rows 1116) between the pair of consecutive rows 1116. In other implementations, the width of chasing zone 1104-1 may be larger or greater than the spacing between the pair of consecutive rows 1116.

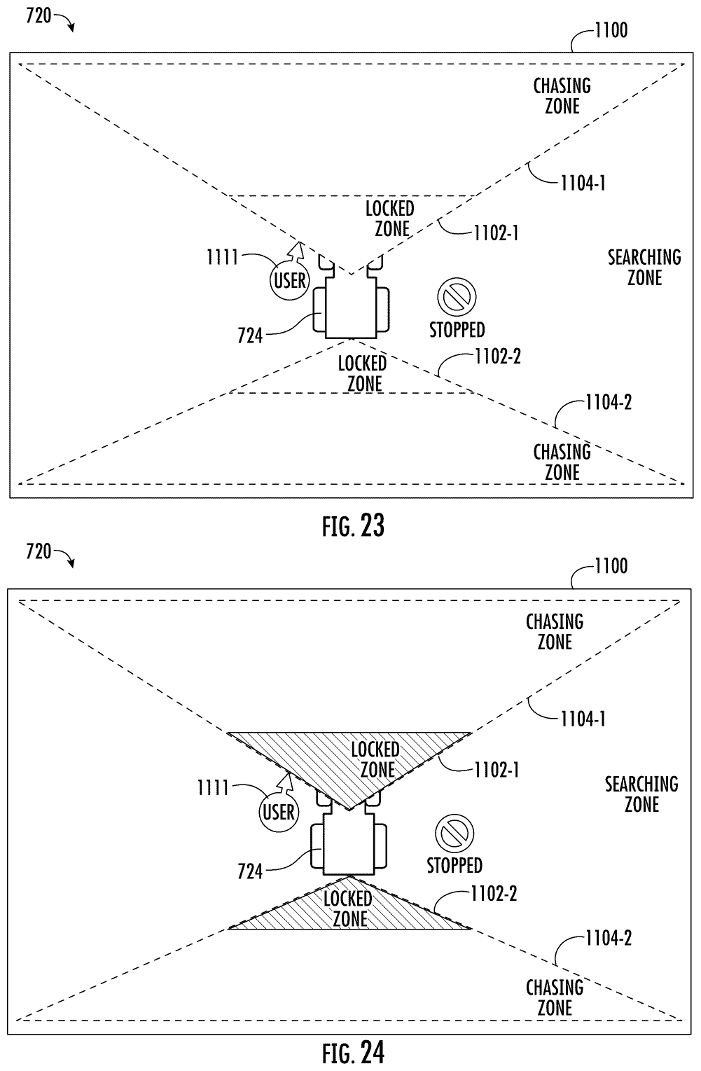

FIGS. 23-37 illustrate various examples of system 720 with controller 825 operating pursuant to method 1000. Each of the states shown in FIGS. 23, 24, 25, 26, 27, 29, 30, 31, 32, 33, 34, 36 and 37 is at a point in time at which controller 825 has received the offboard follow mode entry request which is still active (dead man button), wherein an offboard follow mode exit request has not yet been input are received following the entry request. Each of the state shown in FIGS. 23 and 28 follows the input of the offboard follow mode exit request.

FIG. 23 illustrates system 720 not currently in a follow mode, following exit of the user/operator 1111 from vehicle 724. In implementations where method 1000 requires block 1004 and the entry of an onboard operator FM entry request input, FIG. 23 illustrates an example where the operator 1111 has provided the onboard operator FM entry request input per block 1004 prior to deboarding vehicle 724. At such time, the vehicle/tractor 724 is stopped, there is no steering, the hazard lights are off and the other lights 750 (HRI-metal halide lamps or other lamps) are actuated by controller 8252 a particular state, such as emitting a particular color such as blue. FIG. 23 illustrates method 1000 described above in FIG. 20 between blocks 1004 and 1008.

FIG. 24 illustrates system 720 immediately following block 1008, where operator 1111 has provided the off forward operator FM entry request (via remote device 850 by depressing or actuating an input graphical user interface or button (sometimes referred to as a “dead man button” or is provided appropriate anatomical gestures which are recognized by controller 825 as providing the FM entry request. At such time, the follow mode has not yet been entered. The vehicle 724 is stopped and no steering is taking place. The hazard lights are off. The state of the lights and 50 remains unchanged, such as continuing to omit the color blue. In other implementations, controller 25 may output control signals causing lights to emit a different color indicating that the offboard operator FM entry request input has been recognizing received.

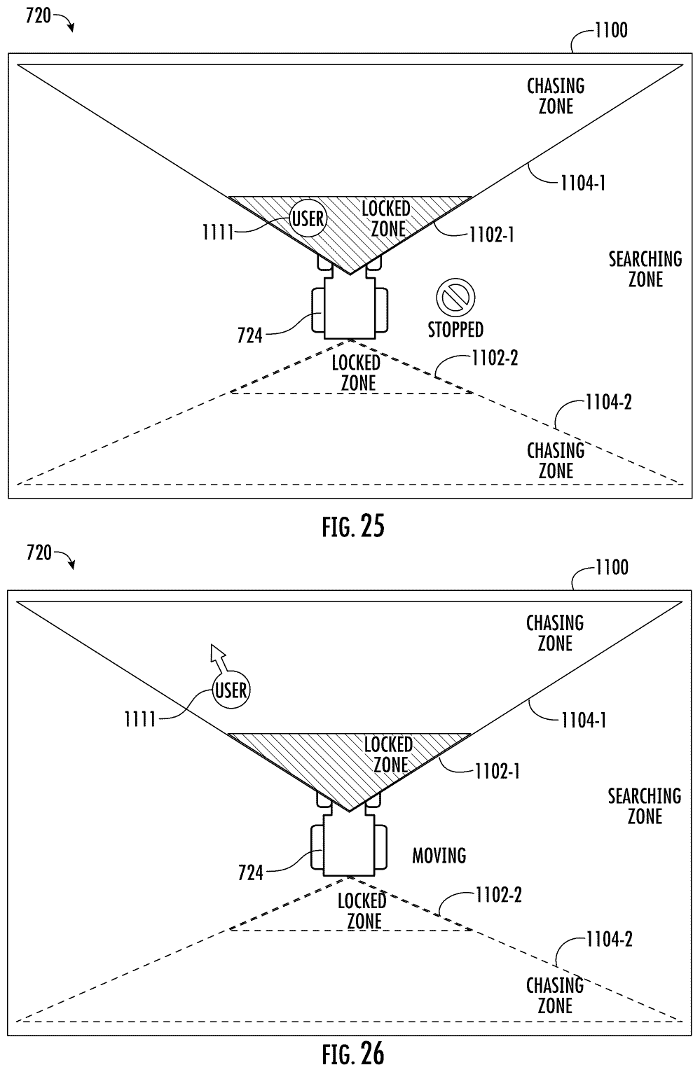

FIG. 25 illustrates system 720 between blocks 1012 and 1018 and method 1000. Remote operator 1111 is currently residing within zone 1102-1. Controller 825 has “locked” onto operator 1111. At such time, vehicle 724 remains stopped with no steering taking place. Controller 825 outputs control signals causing the hazard lights to blink a particular number of times (twice in one implementation) and causing at least one of light 752 change state, such as causing such lights to emit a different color of light (green in one example implementation). Such confirms to the remote operator that he or she is indeed locked and ready for tracking.

FIG. 26 illustrates system 720 after system 720 has entered the forward following mode in response to the remote operator 1111 entering zone 1104-1 (corresponding to the point between blocks 1020 and 1022 and method 1000 shown in FIG. 20). In one implementation, controller 825 outputs control signals to the propulsion and steering systems of vehicle 7242 Chase operator 1111 with the objective of bringing the operator 1111 back into zone 1102-1. As result, controller 25 may be outputting control signals propelling vehicle 724 forwardly at a non-nonzero speed and steering vehicle 724 to the left (as seen in FIG. 26). At the same time, controller 825 may be outputting control signals causing at least one of the lights 752 change state indicating that the chasing or following is ongoing. For example, one implementation, controller 825 may output control signals causing at least one of lights 752 omit a and orange colored light. During such times, controller 825 may output controls eight is causing the hazard lights to also blink.

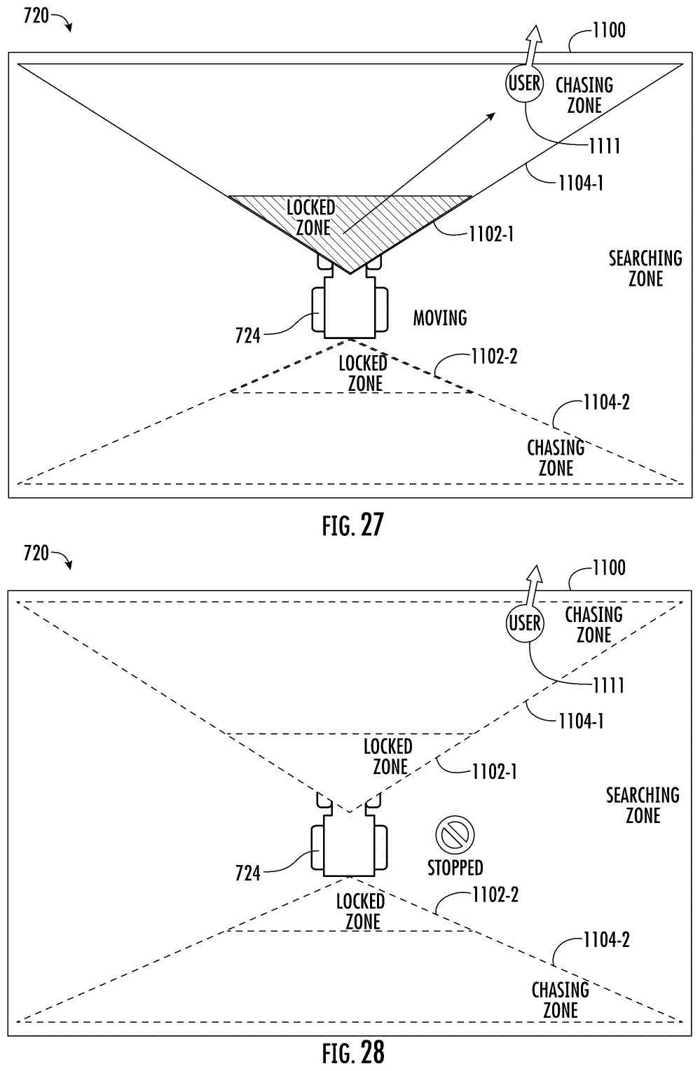

FIG. 27 illustrates system 720 in the same state as shown in FIG. 26, but where the remote operator 1111 is in the illustrated location. In the illustrated scenario, controller 825 is outputting control signals causing vehicle 724 to be driven forward at a greater speed than that shown in FIG. 26 as the user 1111 is increasing his or her distance from vehicle 724. Controller 825 further outputs control signals causing vehicle 724 to steer to the right. During such time, at least one of the lights and 50 may continue to emit the color orange in the hazard lights remained blinking, indicating a follow mode that is ongoing.

FIG. 28 illustrates system 720 after the operator 1111 has input the offboard operator follow mode exit request while the remote operator 1111 is within the chasing zone 1104-1. In response to receipt of the offboard operator FM exit request or command, controller 825 automatically exits the forward follow mode. As indicated by block 1042 in FIG. 20, the remote operator may input the offboard operator FM exit input (dead man button released) at any time while within zone 1104-1 or zone 1104-2 which automatically results in system's 720 returning to the state between blocks 1004 and 1008 in FIG. 20, once again awaiting receipt of an offboard operator FM entry input request in block 1008. As a result of leaving the forward follow mode, controller 825 stops propulsion and steering of vehicle. Controller 825 may output control signals causing at least one of light 7502 omit a particular color of light, such as blue) indicating a searching mode and indicating that reinstatement of a follow mode may require that the user once again return to either of zones 1102-1 or 1102-2 for once again being locked.

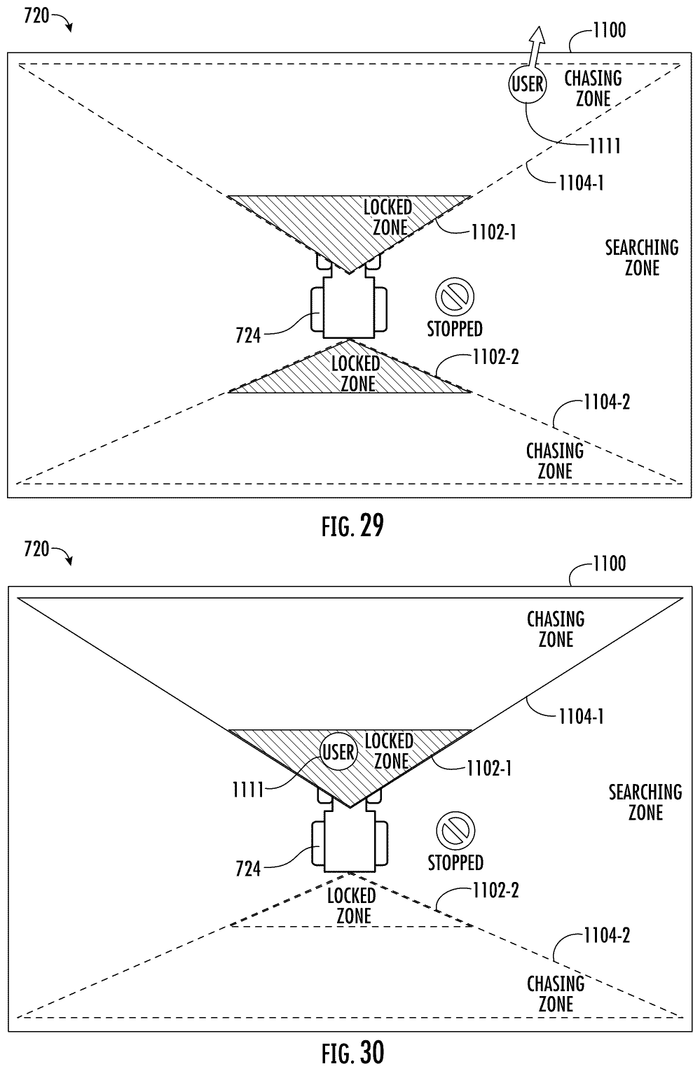

FIG. 29 illustrates system 720 after providing the offboard operator FM entry request input, following the prior input of the offboard operator FM exit request in FIG. 28 (corresponding to block 1042). As discussed above, this input may be provided using the portable remote device 850 by providing an anatomical gesture captured by a camera, such as camera 520-1, and recognized by controller as corresponding to the request. In response to such input, system 720 remains exited from the forward follow mode. Vehicle 724 remains in a stopped state. However, controller 825 may output control signals causing at least one of lights 750 to continue to emit the color blue indicating a searching motor indicating that the operator must reenter one of zones 1102 two once again will be locked onto by system 720. In some implementations, system 720 and method 1000 may alternatively automatically return to the forward follow mode in response to input of the offboard operator FM entry request.

FIG. 30 illustrates system 720 after the remote operator 1111 as once again return to zone 1102-1, following the input of the offboard operator FM entry request in FIG. 29. As result, system 720 effective returns to the state between blocks 1012 and 1018 in method 1000 shown in FIG. 20. As result, tractor or vehicle 724 remains stopped with no steering. However, controller 825 outputs control signals causing at least one of light 7502 change state. For example, in one implementation, controller 825 may output control signals causing the at least one light 750 to change to a green light emitting color, indicating that system 720 has locked onto the operator 1111 and is ready to enter the forward follow mode upon the operator entering the chasing zone 1104-1. Upon locking onto the operator 1111, controller 25 may output controls of the causing the hazard lights to blink a predetermined number of times, confirming the lock.

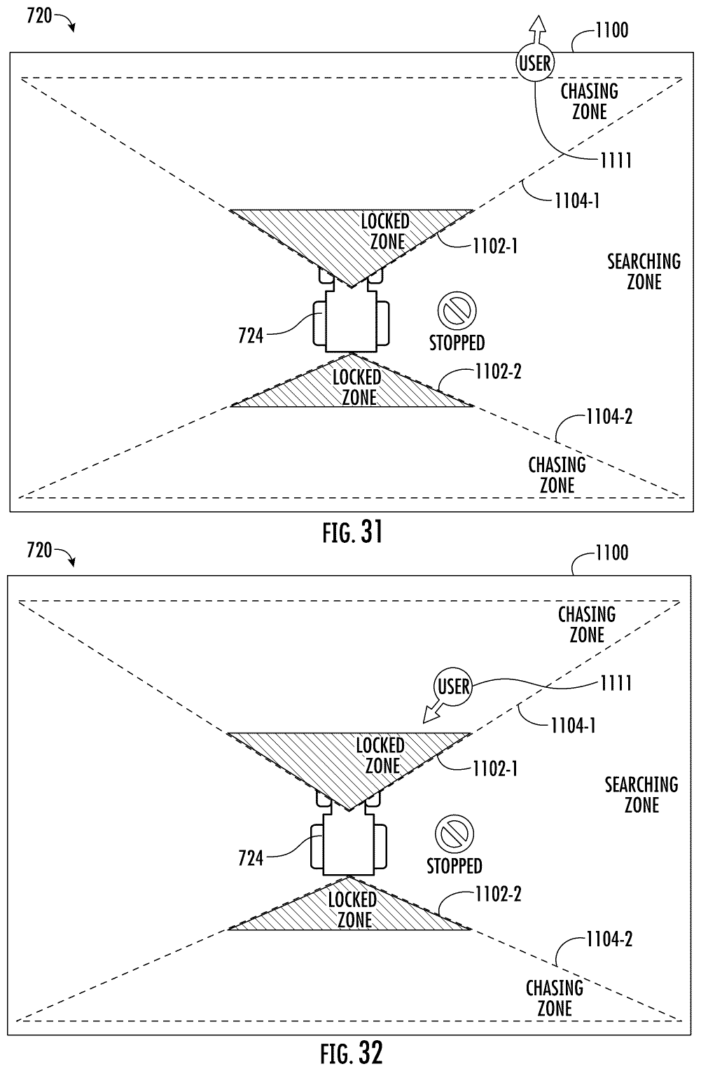

FIG. 31 illustrates an example circumstance where the operator 1111 has moved so fast that the operator 1111 has exited the chasing zone 1104-1. Vehicle 724 could not keep pace with movement of the operator 1111 in the forward direction. FIG. 31 corresponds to block 1024 of method 1000 in FIG. 20. As a result, system 720 exits the forward follow mode. For propulsion of the vehicle 724 is stopped. Controller 825 may output control signals causing at least one of lights and 52 change state, once again admitting the color blue to indicate that controller 825 is once again searching for the operator. In the example illustrated, the hazard lights are turned off.

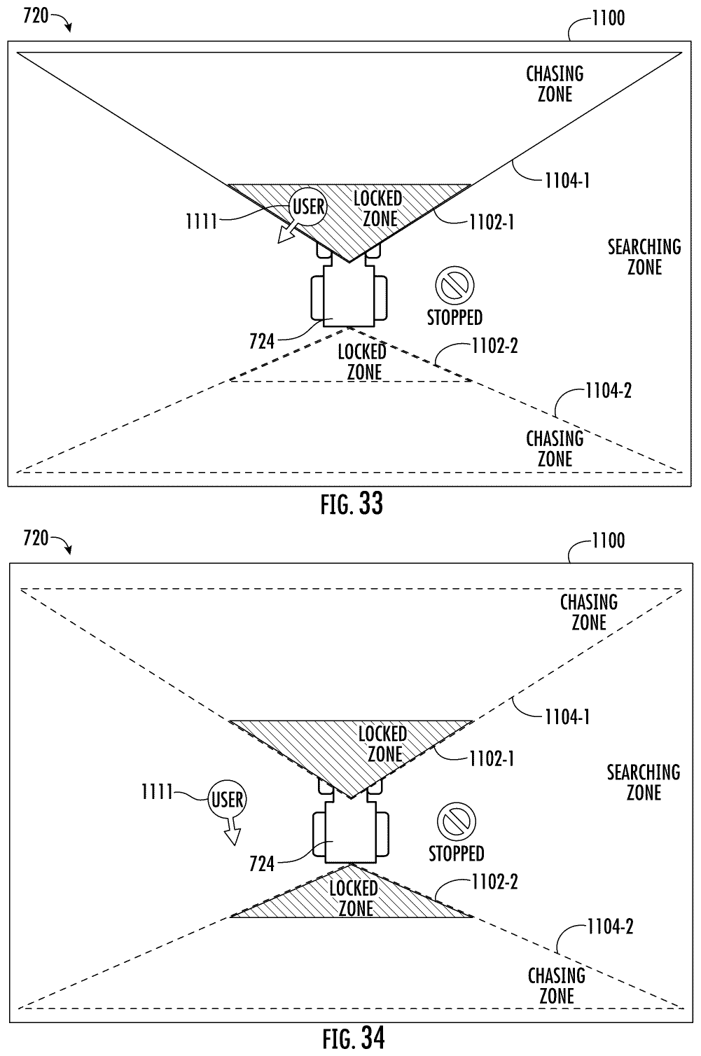

FIG. 32 illustrates system 720 merely following the state shown in FIG. 31, where the remote operator 1111 is returning to the locked zone 1102-1 to reinstate the forward follow mode. FIG. 33 illustrates return of the operator 1111 to the locked zone 1102-1. As result, controller 8250 to lock onto the operator 1111 once again, returning to the state blocks 1012 and 1018 and method 1000. At such time, the tractor or vehicle 724 remains in a stopped state. However, controller 825 outputs control signals causing at least one of light 7502 change state such as by omitting a different color, the color green indicating that the operator is once again been locked. Controller 25 may further cause the hazard lights to blink twice further confirming completed locking. Thereafter, the remote operator 1111 may once again return to the chasing zone 1104-1 to complete reentry into the follow mode.

FIG. 34 illustrates an example circumstance where the operator has left the chasing zone 1104-1, such as when the operator 1111 is moving towards the rear of the tractor. This results in system 720 being in the state represented by block 1024 in method 1000 in FIG. 20 causing controller 825 to exit the forward following mode and resulting in forward propulsion and steering of vehicle 724 being automatically stopped. Controller 825 outputting control signals causing at least one of light 7502 change state, omitting a color, such as a color blue to indicate a searching for the operator is ongoing. During such time, the hazard lights may be turned off.

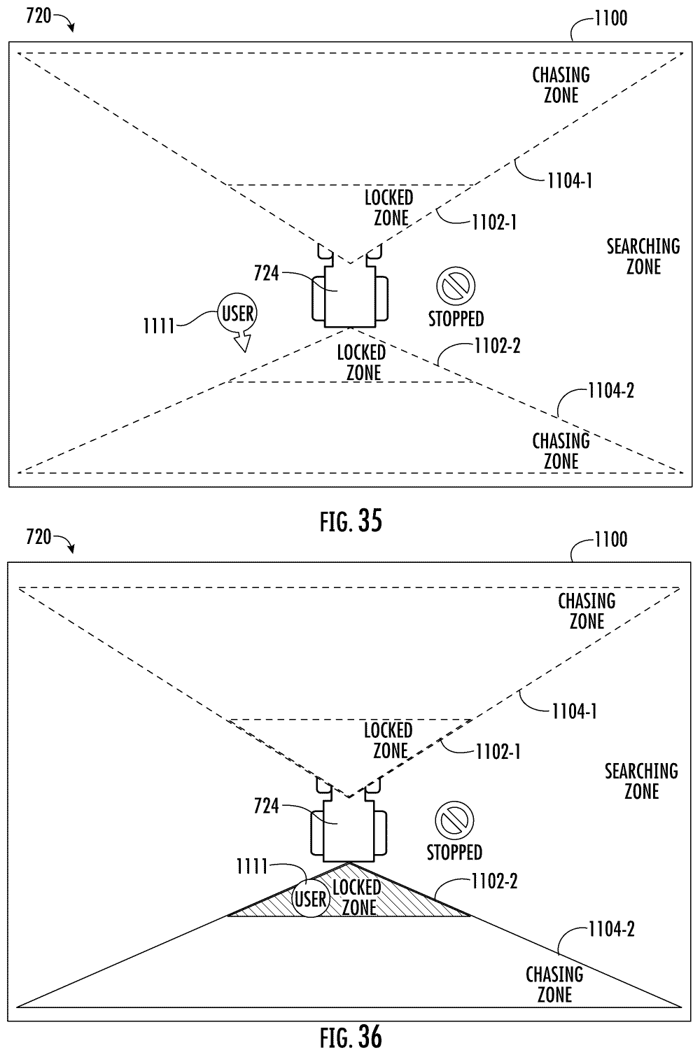

FIG. 35 illustrates an example circumstance where the operator 1111 has additionally provided the offboard operator FM exit request (dead man button released) (corresponding to block 1026 in method 1000). As result, to potentially reenter a follow mode, forward or rearward, the operator cannot simply return to a locked zone, must additionally provide the offboard operator FM entry request in block 1008. FIG. 36 mode operator is once again entered the offboard operator follow mode entry request in block 1008 (dead man button pressed) and has entered locked zone 1102-2 (block 1016 in method 1000). As with the example state shown in FIG. 33, controller 825 is locked onto operator 1111 to facilitate tracking of operator 1111. As noted above, in some implementations, such locking may further involve confirming that the operator 1111 is authorized to use a follow mode. At such time, vehicle 724 remains stopped. Controller 825 outputs control signals causing at least one of lights 750 to change state,, such as emitting a color of light that indicates that the operator is currently locked, but the follow mode has not yet been initiated. In the example illustrated, control 825 causes at least one of lights 750 to emit the color green. System 720 is a standby mode (block 1028 in FIG. 20) until the operator 1111 enters chasing zone 1104-2 (zone 4).

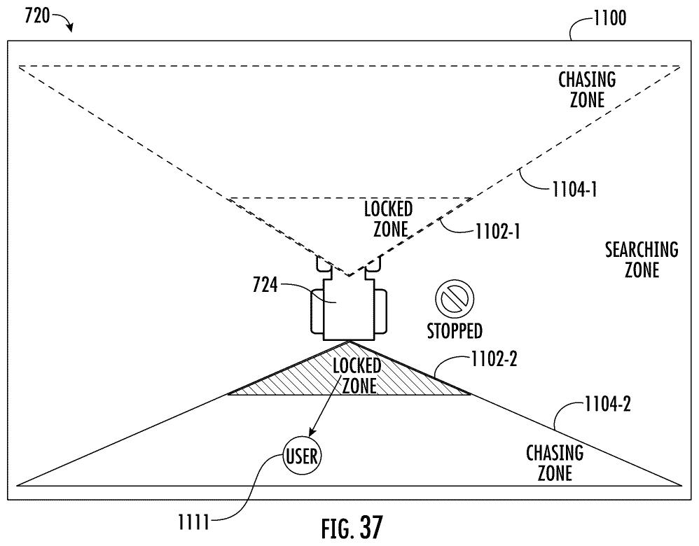

FIG. 37 illustrates an example circumstance where the operator 1111, following being locked by system 720 in zone 1102-2, has traveled into zone 1104-2. The state shown in FIG. 37 corresponds to block 1030 in method 1000 in FIG. 20. As result, enters the rearward follow mode in which vehicle 724 backs up at a speed and with a direction based upon rearward movement of operator 1111 in the chasing zone 1104-2. During such time, controller 825 may be outputting control signals causing or controlling the rearward propulsion and rearward steering of vehicle 724. Controller 825 may further output control signals causing at least one of lights and 52 change states, such as changing to the color orange to indicate a chasing or falling the output in addition, controller 825 may output signals such that the hazard lights blink during such a rearward follow mode.

Although each of the modes shown and described with respect to FIG. 16-39 are described in the context of being implemented by controller 825 of vehicle 724, each of the safe mode and follow mode may likewise be performed by vehicle 524. For example, medium 540 may include instructions configured direct processor 32 to carry out the described safe mode and follow mode. Such modes may be concurrently performed in some implementations.

Although the claims of the present disclosure are generally directed to the vehicle, such as a tractor that automatically changes operative states based upon which of a plurality of predefined zones in which a remote, offboard operator may currently reside, the present disclosure is additionally directed to the features set forth in the following definitions.

Definition 1. A vehicle control system comprising:
a vehicle having a propulsion unit and a steering unit;
a forward-facing camera carried by the vehicle;
a processor; and
a non-transitory computer-readable medium comprising operator position identification instructions to direct the processor to:
   identify relative positioning of a remote operator on ground proximate the vehicle based upon signals from the forward-facing camera; and
   control the propulsion unit and the steering unit of the vehicle to follow the operator based upon the relative positioning of the remote operator on the ground proximate the vehicle.

Definition 2. The vehicle control system of Definition 1, wherein the processor is configured to control the propulsion unit and the steering unit of the vehicle to follow the operator at a preselected distance or an operator selected distance.

Definition 3. The vehicle control system of Definition 1, wherein the processor is configured to control the propulsion unit and the steering unit of the vehicle based upon a speed at which the operator is moving.

Definition 4. The vehicle control system of Definition 3, wherein the processor is configured to control the propulsion unit to match the speed at which the operator is moving.

Definition 5. The vehicle control system of Definition 1 further comprising a light carried by the vehicle, wherein the processor is configured to control lighting provided by the light based upon signals from the forward-facing camera.

Definition 6. The vehicle control system of Definition 1 further comprising:
remote operator input sensing instructions to direct the processor to obtain a sensed input from the forward-facing camera;
input recognition instructions to direct the processor to recognize and associate the sensed input with a vehicle action; and
input response control instructions to direct the processor to output control signals to the vehicle based on the sensed input to cause the vehicle to carry out the vehicle action.

Definition 7. The vehicle control system of Definition 6, wherein the sensed input comprises a captured image of movement and/or positioning of an anatomy of the operator.

Definition 8. The vehicle control system of Definition 6, wherein the vehicle action is selected from a group of vehicle actions consisting of: forward velocity, backward velocity, left/right direction, braking, lights (nightlights, running lights, spotlights), signal, sounds (horn, loudspeaker), warning (flashing lights, hazard lights), implement specific actions (left sprayer on/off, right sprayer on/off), power take up, moving a discharge spout; turning on/off a power take off; adjusting a speed of a power take off; and raising/lowering of an attachment to the vehicle.

Definition 9. The vehicle control system of Definition 6, wherein the vehicle comprises a tractor having a front/rear attachment and wherein the vehicle action comprises adjustment of a state of the front/rear attachment by the tractor.

Definition 10. The vehicle control system of Definition 1, wherein the operator position identification instructions are configured to direct the processor to output a notification to the operator recommending that the operator move relative to the vehicle based upon the positioning.

Definition 11. The vehicle control system of Definition 6, wherein the processor is configured to automatically interrupt the vehicle action corresponding to the sensed operator input based upon the positioning and the vehicle action being requested.

Definition 12. The vehicle control system of Definition 6, wherein the forward-facing camera has a first field-of-view, the system further comprising:
a second camera carried by the vehicle and having a second field-of-view different than the first field-of-view, the second camera being configured to output a second sensed input, as sensed by the second camera, from the operator proximate the vehicle, but not carried by the vehicle;
a first set of associated sensed inputs and first vehicle actions;
a second set of associated sensed inputs and second vehicle actions different than the first vehicle actions,
wherein the first set comprises a first particular sensed input associated with a particular first vehicle action not found in the second set and wherein the second set comprises a second particular sensed input associated with a particular second vehicle action not found in the first set and different than the particular first vehicle action;
wherein the input response control instructions direct the processor:
to consult the first set and to cause the vehicle to perform the particular first vehicle action in response to receiving the particular first sensed input; and
to consult the second set and to cause the vehicle to perform the particular second vehicle action in response to receiving the particular second sensed input.

Definition 13. The vehicle control system of Definition 12, wherein the particular second sensed input is the same as the particular first sensed input.

Definition 14. The vehicle control system of Definition 6, wherein the processor is configured to determine a state of the vehicle, the system further comprising:
a first set of associated sensed inputs and first vehicle actions;
a second set of associated sensed inputs and second vehicle actions different than the first vehicle actions,
wherein the first set comprises a first particular sensed input associated with a particular first vehicle action not found in the second set and wherein the second set comprises a second particular sensed input associated with a particular second vehicle action not found in the first set and different than the particular first vehicle action, and
wherein the input response control instructions direct the processor:
   to consult the first set and to cause the vehicle to perform the particular first vehicle action in response to a determination by the processor that the vehicle is in a first particular state; and
   to consult the second set and to cause the vehicle to perform the particular second vehicle action in response to a determination by the processor that the vehicle is in a second particular state.

Definition 15. The vehicle control system of Definition 14, wherein the particular second sensed input is the same as the particular first sensed input.

Definition 16. The vehicle control system of Definition 6 further comprising a side facing camera carried by the vehicle, the remote operator input sensing instructions being configured to direct the processor to obtain a second sensed input from the side-facing camera, wherein the input response control instructions are configured to:
direct the processor to output control signals to the vehicle to cause forward movement of the vehicle in response to the second sensed input; and
not direct the processor to output control signals to the vehicle to cause forward movement of the vehicle in response to the first sensed input despite the first sensed input being equal to the second sensed input.

Definition 17. The vehicle control system of Definition 1, wherein the system offers a set of available vehicle actions for control based upon a sensed input from the forward-facing camera and wherein the system is configured to provide a selected subset of the set of available vehicle actions for control based upon the sensed input from the forward-facing camera, the subset being based upon human authorization.

Definition 18. The vehicle control system of Definition 1, wherein the vehicle comprises a tractor having a front hood and at least one light extending along at least one of a front and at least one side of the front hood and wherein the processor is configured to actuate the least one light between different non-zero light emitting states selected from a group of light emitting states consisting of colors, shades of colors, brightness levels or illumination frequencies to indicate status information to the operator.

Definition 19. A vehicle control system comprising:
a vehicle;
a plurality of cameras carried by the vehicle; and
a controller to output control signals causing a vehicle action, the control signals and the resulting vehicle action being based upon contents of an image received from a particular camera of the plurality of cameras and which of the plurality of cameras the image was received.

Definition 20. The vehicle control system of Definition 19, wherein the contents of the image upon which the vehicle action is partially based comprises an anatomical gesture of the remote operator.

Definition 21. A vehicle control system comprising:
a vehicle having a propulsion unit and a steering unit;
at least one camera carried by the vehicle;
a processor; and
a non-transitory computer-readable medium comprising operator position identification instructions to direct the processor to:
   identify relative positioning of a remote operator on ground proximate the vehicle based upon signals from the at least one camera;
   control the propulsion unit and the steering unit of the vehicle based upon the relative positioning of the remote operator on the ground proximate the vehicle; and
   control lighting, and/or auditory emissions and/or vehicle operations (such as power takeoff operation) based on signals from the at least one camera.

Definition 22. A tractor follow and safe control system comprising:
a tractor having a propulsion unit and a steering unit;
at least sensor carried by the tractor;
a processor; and
a non-transitory computer-readable medium comprising:
   stored data defining a plurality of zones proximate the tractor, the plurality of zones including a first zone and a second zone;
   instructions to direct the processor to:
   determine in which of the plurality of zones a remote operator on ground proximate the tractor currently resides based upon signals from the at least one sensor;
   output first control signals to at least one of the propulsion unit and the steering unit of the vehicle in response to a determination that the remote operator currently resides in the first zone; and
   output second control signals to at least one of the propulsion unit and the steering unit of the vehicle in response to a determination that the remote operator currently resides in the second zone.

Definition 23. The system of Definition 22, wherein the system is operable in a follow mode in which the tractor follows movement of the remote operator and is configured to initiate the follow mode in response to: (1) an onboard operator input received by the processor requesting initiation of the follow mode; (2) an offboard operator input received by the processor requesting initiation of the follow mode; (3) the remote operator having been locked onto while residing within the first zone; and (4) a determination by the processor that the remote operator is currently in the second zone.

Definition 24. The system of Definition 23, further comprising a remote input device configured to communicate with the process in a wireless fashion from a location offboard the tractor, wherein the processor is configured to receive the offboard operator input from the remote input device.

Definition 25. The system of Definition 23, wherein the offboard operator input comprises a predefined anatomical gesture from the remote operator.

Definition 26. The system of Definition 23, wherein the system is configured to automatically exit the follow mode in response to a determination that the remote operator is currently locked onto and currently resides in the first zone.

Definition 27. The system of Definition 23, wherein the system is configured to automatically exit the follow mode in response to a determination by the processor that the remote operator is no longer within either the first zone or the second zone.

Definition 28. The system of Definition 27, wherein the system is configured to automatically reenter the follow mode after automatic exit from the follow mode upon reentry of the remote operator into the first zone.

Definition 29. The system of Definition 23, wherein the first zone and the second zone are forward the tractor and wherein the plurality of zones further comprises a third zone and a fourth zone rearward the tractor, the first zone and the second zone being separated from the third zone and the fourth zone along sides of the tractor by a fifth zone, wherein the system is further configured to initiate the follow mode in response to: (1) the onboard operator input received by the processor requesting initiation of the follow mode; (2) the offboard operator input received by the processor requesting initiation of the follow mode; (3) the remote operator having been locked onto while residing within the third zone; and (4) a determination by the processor that the remote operator is currently in the fourth zone.

Definition 30. The system of any of Definitions 23-29 further comprising a portable remote device configured to be carried by the remote operator and in wireless communication with the controller, the remote device comprising a first GPS locator and the vehicle comprising a second GPS locator, wherein the controller is configured to determine relative positioning of the remote operator with respect to the first zone and the second zone based upon signals from the first GPS locator and the second GPS locator.

Although the present disclosure has been described with reference to example implementations, workers skilled in the art will recognize that changes may be made in form and detail without departing from disclosure. For example, although different example implementations may have been described as including features providing various benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A tractor zone control system comprising:
a tractor having a propulsion unit and a steering unit;
at least one camera carried by the tractor;
a processor; and
a non-transitory computer-readable medium comprising:
stored data defining a plurality of zones proximate the tractor, the plurality of zones including a first zone and a second zone;
instructions to direct the processor to:
determine in which of the plurality of zones a remote operator on ground proximate the tractor currently resides based upon signals from the at least one camera;
output first control signals to at least one of the propulsion unit and the steering unit of the tractor in response to a determination that the remote operator currently resides in the first zone; and
output second control signals to at least one of the propulsion unit and the steering unit of the tractor in response to a determination that the remote operator currently resides in the second zone.

2. The system of claim 1 further comprising a light carried by the tractor, wherein the first control signals cause the light to operate in a first mode and wherein the second control signals causing light to operate in a second mode.

3. The system of claim 2, wherein the light is at a location selected from a group of locations consisting of: (1) on an exterior of an operator cab roof of the tractor; (2) along an exterior of a front hood of the tractor; and (3) on an external portion of wheel fender of the tractor.

4. The system of claim 2 further comprising an auditory output device, wherein the first control signals cause the auditory output device to operate in a first mode and wherein the second control signals causing auditory output device to operate in a second mode.

5. The system of claim 1 further comprising an auditory output device, wherein the first control signals cause the auditory output device to operate in a first mode and wherein the second control signals causing auditory output device to operate in a second mode.

6. The system of claim 1, wherein the first zone encompasses and surrounds the tractor and wherein the second zone at least partially encompasses and at least partially surrounds the first zone.

7. The system of claim 6, wherein the first zone is rectangular and is proportional to a transverse width of the tractor and wherein the second zone completely encompasses and surrounds the first zone.

8. The system of claim 1, wherein the first zone comprise has a triangular shape that widens in a forward direction from the tractor and wherein the second zone has trapezoidal shape adjacent a front of the first zone and widening in a direction away from the first zone.

9. The system of claim 8, wherein the plurality of zones comprise a third zone and a fourth zone, wherein the instructions are further configured to direct the processor to:
output third control signals to at least one of the propulsion unit and the steering unit of the tractor in response to a determination that the remote operator currently resides in the third zone; and
output fourth control signals to at least one of the propulsion unit and the steering unit of the tractor in response to a determination that the remote operator currently resides in the fourth zone,
wherein the third zone comprise has a triangular shape that widens in a rearward direction from the tractor and wherein the fourth zone has trapezoidal shape adjacent a rear of the first zone and widening in a direction away from the first zone.

10. The system of claim 9, wherein the plurality of zones further comprises a fifth zone extending on a lateral sides of the tractor between the first zone and the third zone and between the second zone and the fourth zone.

11. The system of claim 1, wherein the first zone has a triangular shape that widens in a rearward direction from the tractor and wherein the second zone has trapezoidal shape adjacent a rear of the first zone and widening in a direction away from the first zone.

12. The system of claim 1, wherein the first zone has a first size when the tractor is in a first operative state and has a second size, different than the first size, when the tractor is in a second different operative state.

13. The system of claim 1, wherein the system is operable in a follow mode in which the tractor follows movement of the remote operator and is configured to initiate the follow mode in response to: (1) an offboard operator input received by the processor requesting initiation of the follow mode; (2) the remote operator having been locked onto while residing within the first zone; and (3) a determination by the processor that the remote operator is currently in the second zone.

14. The system of claim 13, wherein the system is configured to additionally require receipt of an onboard operator follow mode entry request to enter the follow mode.

15. The system of claim 13, further comprising a remote input device configured to communicate with the process in a wireless fashion from a location offboard the tractor, wherein the processor is configured to receive the offboard operator input from the remote input device.

16. The system of claim 13, wherein the offboard operator input comprises a predefined anatomical gesture from the remote operator.

17. The system of claim 13, wherein the system is configured to automatically exit the follow mode in response to a determination that the remote operator is currently locked onto and currently resides in the first zone.

18. The system of claim 13, wherein the system is configured to automatically exit the follow mode in response to a determination by the processor that the remote operator is no longer within either the first zone or the second zone.

19. The system of claim 13, wherein the first zone and the second zone are forward the tractor and wherein the plurality of zones further comprises a third zone and a fourth zone rearward the tractor, the first zone and the second zone being separated from the third zone and the fourth zone along sides of the tractor by a fifth zone, wherein the system is further configured to initiate the follow mode in response to: (1) the onboard operator input received by the processor requesting initiation of the follow mode; (2) the offboard operator input received by the processor requesting initiation of the follow mode; (3) the remote operator having been locked onto while residing within the third zone; and (4) a determination by the processor that the remote operator is currently in the fourth zone.

20. A vehicle control system comprising:
a vehicle having a propulsion unit and a steering unit;
at least one sensor carried by the vehicle;
a processor; and
a non-transitory computer-readable medium comprising operator position identification instructions to direct the processor to:
identify relative positioning of a remote operator on ground proximate the vehicle based upon signals from the at least one sensor;
control the propulsion unit and the steering unit of the vehicle based upon the relative positioning of the remote operator on the ground proximate the vehicle; and
control lighting and auditory emissions based on the relative positioning of the remote operator on the ground proximate the vehicle.
